(19) United States
(12) Patent Application Publication
(10) Pub. No.: US 2023/0236474 A1
(43) Pub. Date: Jul. 27, 2023

(54) ACTUATOR ASSEMBLY

(71) Applicant: CAMBRIDGE MECHATRONICS LIMITED, Cambridge, Cambridgeshire (GB)

(72) Inventors: Stephen Matthew Bunting, Cambridge (GB); Oliver Hart, Cambridge (GB); Joshua Carr, Cambridge (GB); David Ooi, Cambridge (GB); Andrew Benjamin Simpson Brown, Cambridge (GB); James Howarth, Cambridge (GB); Robin Eddington, Cambridge (GB)

(21) Appl. No.: 17/919,027

(22) PCT Filed: Apr. 16, 2021
(86) PCT No.: PCT/GB2021/050922

§ 371 Date: Oct. 14, 2022

(30) Foreign Application Priority Data
Apr. 16, 2020 (GB) 2005573.7
Nov. 17, 2020 (GB) 2018082.4
Nov. 17, 2020 (GB) 2018083.2

(51) Int. Cl. G03B 3/10; G03B 5/00

(52) U.S. Cl. CPC G03B 3/10; G03B 5/00; G03B 2205/0076; G03B 2205/0015

(57) ABSTRACT

An actuator assembly (23) includes a first part (24), a second part (25), and a bearing arrangement (26) mechanically coupling the first part (24) to the second part (25). The actuator assembly (23) also includes a drive arrangement (11, 20) including a total of four lengths of shape memory alloy wire (141, 142, 143, 144). The drive arrangement (11, 20) and the bearing arrangement (26) are configured such that the second part (25) is movable towards or away from the first part (24) along a primary axis (z), and the second part (25) is movable relative to the first part (24) along a first axis (x) and/or a second axis (y). The first and second axes (x, y) are perpendicular to the primary axis (z) and the second axis (y) is different to the first axis (x).

### FIELD

The present application relates to an actuator assembly, particularly an actuator assembly comprising four shape-memory alloy (SMA) wires.

### BACKGROUND

Such an actuator assembly may be used, for example, in a camera to move a lens assembly in directions perpendicular to an optical axis so as to provide optical image stabilization (OIS), and to move the lens assembly along the optical axis to provide automatic focussing (AF). Where such a camera is to be incorporated into a portable electronic device such as a mobile telephone, miniaturization can be important.

WO 2013/175197 A1 describes an SMA actuation apparatus which moves a movable element relative to a support structure in two orthogonal directions using a total of four SMA actuator wires each connected at its ends between the movable element and the support structure and extending perpendicular to the primary axis. None of the SMA actuator wires are collinear, but the SMA actuator wires have an arrangement in which they are capable of being selectively driven to move the movable element relative to the support structure to any position in said range of movement without applying any net torque to the movable element in the plane of the two orthogonal directions around the primary axis.

WO 2019/243849 A1 describes a shape memory alloy actuation apparatus which comprises a support structure and a movable element. A helical bearing arrangement supported on the movable element on the support structure guides helical movement of the movable element with respect to the support structure around a helical axis. At least one shape memory alloy actuator wire is connected between the support structure and the movable element in, or at an acute angle to, a plane normal to the helical axis, so as to drive rotation of the movable element around the helical axis which the helical bearing arrangement converts into said helical movement.

WO 2019/086855 A1 describes a camera with an actuator assembly including a support platform, a moving platform that supports a lens assembly, SMA wires connected to the support platform and the moving platform, bearings to bear the moving platform on the support platform, and two arms extending between the support platform and the moving platform.

### SUMMARY

According to a first aspect of the present invention, there is provided an actuator assembly including a first part, a second part, and a bearing arrangement mechanically coupling the first part to the second part. The actuator assembly also includes a drive arrangement including a total of four lengths of shape memory alloy wire. The drive arrangement and the bearing arrangement are configured such that the first part is movable towards or away from the second part along a primary axis, and the first part is movable relative to the second part along a first axis and/or a second axis. The first and second axes are perpendicular to the primary axis and the second axis is different to the first axis.

The movement of the first part towards or away from the second part along the primary axis, the movement of the first part relative to the second part along the first axis and the movement of the first part relative to the second part along the second axis may be substantially independent from one another. The movement of the first part towards or away from the second part along the primary axis may be controllable substantially independently from the movement of the first part relative to the second part along the first axis and/or the second axis.

The drive arrangement including a total of four lengths of shape memory alloy wire means that, for example, the drive arrangement does not include any further lengths of shape memory alloy wire or other driving means. Notwithstanding this, as will be appreciated, the actuator assembly (or a device including the actuator assembly) may include additional shape memory alloy wire(s) with function(s) other than the driving function specified herein.

The bearing arrangement may be configured to constrain rotation of the first part relative to the second part about the first and/or second axes. The first axis and/or the second axis may be perpendicular to the primary axis. The first axis may be perpendicular to the second axis.

Each of the four lengths of shape memory alloy wire may correspond to a section of shape memory alloy wire over which a drive current may be controlled independently. For example, a pair of lengths of shape memory alloy wire may be provided by a single physical wire having a first current source connected to one end, a second current source connected to the other end and a current return connection at a point between the two ends.

The bearing arrangement may include a first bearing configured to generate, in response to a torque applied about the primary axis by the drive arrangement, movement of the first part towards or away from the second part along the primary axis.

The first bearing may guide helical movement about and along the primary axis. The first bearing may mechanically couple a rotation about the primary axis to a translation along the primary axis. The first bearing may take the form of a helical flexure. The first bearing may take the form of a helical bearing. The first bearing may include one or more helical tracks. The first bearing may include a number of ramps arranged in a loop. The ramps may be flexible. Flexible ramps may be pre-stressed in an equilibrium or neutral configuration of the helical bearing.

A helical flexure may take the form of a flat ring (or annulus) and at least three flexures extending from the flat ring. There may be four or more flexures extending from the flat ring. The flexures may be attached at equally-spaced angles around the flat ring. The flat ring and flexures may be a single-piece.

A rotation of the first bearing about the primary axis may correspond to a rotation of the first part relative to the second part.

The first bearing may mechanically couple the second part to a third part. Each of the four lengths of shape memory alloy wire may connect the first part to the second part. The bearing arrangement may include a second bearing mechanically coupling the first part to the third part and configured to guide movement of the first part relative to the third part along the first axis and/or the second axis.

The second bearing may constrain rotation of the first part relative to the third part about the primary axis.

The second bearing may include a first ball-bearing race aligned with the first axis and connected in series with a second ball-bearing race aligned with the second axis.

The first ball bearing race may constrain movement along the second and primary axes. The second ball bearing race may constrain movement along the first and primary axes. The second ball bearing race and the first ball bearing race may be stacked along the primary axis. The second ball bearing race may be substantially coplanar with the first ball bearing race.

The second bearing may include a central plate in sliding contact with a first plate and a second plate. The first and second plates may be urged into contact with the central plate by respective biasing means. The first plate may be constrained to slide along the first axis by one or more features extending from the central plate. The second plate may be constrained to slide along the second axis by one or more features extending from the central plate. The one of more features may include one or more protrusions extending from the central plate parallel to the primary axis, and received into holes of the first plate which extend parallel to the first axis and/or holes of the second plate which extend parallel to the second axis. The one or more features may include retaining lips and/or tabs extending from the central plate so as so prevent the first plate and/or second plate from moving away from the central plate along the primary axis.

The second bearing may include a first set of flexures connected in series with a second set of flexures. The first set of flexures may be configured to be compliant in a direction corresponding to movement of the first part relative to the third part along the first axis. The second set of flexures may be configured to be compliant in a direction corresponding to movement of the first part relative to the third part along the second axis.

The first set of flexures may constrain movement of the first part relative to the third part along the second axis. The second set of flexures may constrain movement of the first part relative to the third part along the first axis. The first and/or second set of flexures may be compliant in a direction corresponding to movement of the first part relative to the third part along the primary axis.

One or more, or all of the first and/or second set of flexures may be flat (perpendicular to the primary axis). One or more, or all of the first and/or second set of flexures may include at least one bend (or “turn” or “elbow”). One or more, or all of the first and/or second set of flexures may comprise a respective arm which may include at least one bend. One or more, or all of the arms may include a first portion extending away from the platform and a second portion running along a respective side of the platform. The first and second portions may be straight.

The bearing arrangement may further include a third bearing mechanically coupling the first part to the third part in parallel with the second bearing.

The third bearing may be configured to constrain movement of the first part relative to the third part along the primary axis, and to constrain rotation of the first part relative to the third part about the first or second axes.

The third bearing may not constrain movement of the first part relative to the third part along the first axis and/or the second axis. The third bearing may not constrain rotation of the first part relative to the third part about the primary axis. The third bearing may take the form of a three-point planar bearing. The third bearing may include at least three cylinders which are arranged at the points of a triangle, wherein a flat surface of each cylinder may provide a sliding surface. The third bearing may include more than three cylinders. The third bearing may include at least three ball-bearings arranged at the points of a triangle. The third bearing may include more than three ball-bearings.

The bearing arrangement may be further configured to constrain rotation of the first part relative to the second part about the primary axis.

The first bearing may mechanically couple the first part to a third part. Each of the four lengths of shape memory alloy wire may connects the second part to the third part. The bearing arrangement may further include a fourth bearing mechanically coupling the first part to the second part and configured to guide movement of the first part relative to the second part along the first axis and/or the second axis.

The fourth bearing may be configured to constrain rotation of the first part relative to the second part about the primary axis.

The fourth bearing may include a first set of flexures connected in series with a second set of flexures. The first set of flexures may be configured to be compliant in a direction corresponding to movement of the first part relative to the second part along the first axis. The second set of flexures may be configured to be compliant in a direction corresponding to movement of the first part relative to the second part along the second axis.

The first set of flexures may constrain movement of the first part relative to the second part along the second axis. The second set of flexures may constrain movement of the first part relative to the second part along the first axis. The first and/or second set of flexures may be compliant in a direction corresponding to movement of the first part relative to the second part along the primary axis.

One or more, or all of the first and/or second set of flexures may be flat (perpendicular to the primary axis). One or more, or all of the first and/or second set of flexures may include at least one bend (or “turn” or “elbow”). One or more, or all of the first and/or second set of flexures may comprise a respective arm which may include at least one bend. One or more, or all of the arms may include a first portion extending away from the platform and a second portion running along a respective side of the platform. The first and second portions may be straight.

The bearing arrangement may further include a fifth bearing mechanically coupling the second part to the third part connected in parallel with the four lengths of shape memory alloy wire.

The fifth bearing may take the same form as the third bearing and/or may include any features and/or functions of the third bearing.

The fifth bearing may be configured to constrain movement of the third part relative to the second part along the primary axis, and to constrain rotation of the third part relative to the second part about the first or second axes.

The bearing arrangement may include sixth and seventh bearings, each mechanically coupling the first part to the second part. The sixth and seventh bearings may be connected in parallel. Each of the four lengths of shape memory alloy wire may connect the first part to the second part. The sixth bearing may include a first set of helical flexures configured to be compliant in directions corresponding to movement of the first part relative to the second part along the primary axis and/or the first axis. The first set of helical flexures may be connected in series with a third set of flexures configured to be compliant in a direction corresponding to movement of the first part relative to the second part along the second axis. The seventh bearing may include a second set of helical flexures configured to be compliant in directions corresponding to movement of the first part relative to the second part along the primary axis and/or the second axis. The second set of helical flexures may be connected in series with a fourth set of flexures configured to be compliant in a direction corresponding to movement of the first part relative to the second part along the first axis.

The sixth bearing may also include a third set of helical flexures connected in parallel with the first set of helical flexures. The third set of helical flexures may be configured to be compliant in directions corresponding to movement of the first part relative to the second part along the primary axis and/or the first axis.

The seventh bearing may also include a fourth set of helical flexures connected in parallel with the second set of helical flexures. The fourth set of helical flexures may be configured to be compliant in directions corresponding to movement of the first part relative to the second part along the primary axis and/or the second axis.

The bearing arrangement may be further configured to constrain rotation of the first part relative to the second part about the primary axis.

Each of the four lengths of shape memory alloy wire may connect the first part to the second part. The bearing arrangement may include an eighth bearing mechanically coupling the second part to a third part and configured to guide movement of the third part relative to the second part along the first axis and/or the second axis. The bearing arrangement may also include a ninth bearing mechanically coupling the first part to the third part and configured to guide movement of the first part relative to the third part along the primary axis.

The eighth bearing may be configured to constrain rotation of the third part relative to the second part about the primary axis.

The eighth bearing may take the same form as the second bearing and/or may include any features and/or functions of the second bearing.

The bearing arrangement may further include a tenth bearing mechanically coupling the second part to the third part in parallel with the eighth bearing.

The tenth bearing may take the same form as the third bearing and/or may include any features and/or functions of the third bearing.

The tenth bearing may be configured to constrain movement of the third part relative to the second part along the primary axis, and to constrain rotation of the third part relative to the second part about the first or second axes.

The ninth bearing may be configured to constrain movement of the first part relative to the third part along the first axis and/or the second axis, and to constrain any rotation of the first part relative to the third part.

The ninth bearing may include a ball-bearing race aligned with the primary axis.

The ninth bearing may include fifth and sixth sets of flexures, each configured to be compliant in a direction corresponding to movement of the first part relative to the third part along the primary axis. The fifth and sixth sets of flexures may be connected in parallel and spaced apart along the primary axis.

The four lengths of shape memory alloy wire may be substantially co-planar within a plane parallel to the first and second axes. The substantially co-planar lengths of shape memory alloy wire may be configured to apply a net force along first and/or second axes, and/or a torque about the primary axis.

Each of the four lengths of shape memory alloy wire may not be perpendicular to the primary axis. First and second lengths of shape memory alloy wire may be oriented at respective angles to the primary axis and may lie substantially in planes parallel to the primary and first axes. Third and fourth lengths of shape memory alloy wire may be oriented at respective angles to the primary axis and may lie substantially in planes parallel to the primary and second axes. The four lengths of shape memory alloy wire oriented at respective angles to the primary axis may be configured to apply a net force along the first axis in combination with a torque about the first axis, a net force along the second axis in combination with a torque about the second axis, and/or a net force along the primary axis in combination with a torque about the primary axis.

A camera may include the actuator assembly. The camera may also include an image sensor supported by one of the first part and the second part. The camera may also include a lens supported by the other of the first part and the second part.

The camera may also include a controller configured to control the actuator assembly to implement an auto-focus function using the movement of the first part towards or away from the second part along the primary axis. The controller may also be configured to implement an optical image stabilisation function using the movement of the first part relative to the second part along the first axis and/or the second axis.

According to a second aspect of the present invention, there is provided a method including use of the actuator assembly to implement an optical image stabilisation function and/or an automatic focussing function of a camera.

According to a third aspect of the present invention, there is provided an actuator assembly including a first part, a second part, and a bearing arrangement mechanically coupling the first part to the second part. The actuator assembly also includes a drive arrangement including more than four lengths of shape memory alloy wire. The drive arrangement and the bearing arrangement are configured such that the first part is movable towards or away from the second part along a primary axis, and the first part is movable relative to the second part along a first axis and/or a second axis. The first and second axes are perpendicular to the primary axis and the second axis is different to the first axis. The bearing arrangement comprises a first bearing configured to generate, in response to a torque applied about the primary axis by the drive arrangement, movement of the first part towards or away from the second part along the primary axis. The actuator assembly may include suitable feature(s) of the first aspect.

The term ‘shape memory alloy (SMA) wire’ (or ‘length of SMA wire’) may refer to any element comprising SMA. The SMA wire may have any shape that is suitable for the purposes described herein. The SMA wire may be elongate and may have a round cross section or any other shape cross section. The cross section may vary along the length of the SMA wire. It is also possible that the length of the SMA wire (however defined) may be similar to one or more of its other dimensions. The SMA wire may be pliant or, in other words, flexible. In some examples, when connected in a straight line between two elements, the SMA wire can apply only a tensile force which urges the two elements together. In other examples, the SMA wire may be bent around an element and can apply a force to the element as the SMA wire tends to straighten under tension. The SMA wire may be beam-like or rigid and may be able to apply different (e.g. non-tensile) forces to elements. The SMA wire may or may not include material(s) and/or component(s) that are not SMA. For example, the SMA wire may comprise a core of SMA and a coating of non-SMA material. Unless the context requires otherwise, the term ‘SMA wire’ may refer to any configuration of SMA wire acting as a single actuating element which, for example, can be individually controlled to produce a force on an element. For example, the SMA wire may comprise two or more portions of SMA wire that are arranged mechanically in parallel and/or in series. In some arrangements, the SMA wire may be part of a larger piece of SMA wire. Such a larger piece of SMA wire might comprise two or more parts that are individually controllable, thereby forming two or more SMA wires.

### BRIEF DESCRIPTION OF THE DRAWINGS

Certain embodiments of the present invention will now be described, by way of example only, with reference to the accompanying drawings, in which:

FIG. 1 schematically illustrates a camera;

FIG. 2 illustrates possible translations and rotations of a lens assembly for a camera as shown in FIG. 1;

FIG. 3 schematically illustrates a first drive arrangement using four shape memory alloy (SMA) wires;

FIG. 4 is a projection view of a flat actuator assembly;

FIGS. 5A to 5C schematically illustrate a second drive arrangement using four shape memory alloy (SMA) wires;

FIG. 6 schematically illustrates a two-bar link bearing;

FIG. 7A is a plan view of a simple flexure bearing, FIG. 7B is a side view of a deformed state of the simple flexure bearing;

FIG. 8 is a plan view of a second simple flexure bearing;

FIG. 9 is an exploded projection view of a z-flexure bearing;

FIG. 10A is a plan view of a first non-rotating general bearing, FIG. 10B is a plan view of a deformed state of the first non-rotating general bearing;

FIG. 11 is a plan view of a second non-rotating general bearing;

FIG. 12 is a plan view of a third non-rotating general bearing;

FIG. 13A is a plan view of a first x-y bearing, FIG. 13B is a cross-section of the first x-y bearing along a line labelled A-A′ in FIG. 13A, and FIG. 13C is a cross-section of the first x-y bearing along a line labelled B-B′ in FIG. 13A;

FIG. 14 is a projection view of the first x-y bearing;

FIG. 15 is an exploded projection view of a second x-y bearing;

FIG. 16 is a projection view of the second x-y bearing;

FIG. 17 is an exploded projection view of a third x-y bearing;

FIG. 18 is a projection view of the third x-y bearing;

FIG. 19 is a projection view of a part of a fourth x-y bearing;

FIG. 20 is a cross-section of the fourth x-y bearing;

FIG. 21A is a side view of a first planar bearing, FIG. 21B is an exploded projection view of the first planar bearing;

FIG. 22 is a side view of a second planar bearing;

FIG. 23A is an exploded projection view of a z-translation bearing, FIG. 23B is a cross section of a portion of the z-translation bearing;

FIG. 24 is a projection view of a helical flexure bearing;

FIG. 25A is an exploded projection view of a helical bearing, FIG. 25B is a projection view of the helical bearing;

FIG. 26 is an exploded projection view of a first combined OIS and AF actuator assembly;

FIG. 27 is a projection view of the first combined OIS and AF actuator assembly;

FIG. 28 schematically illustrates the first combined OIS and AF actuator assembly;

FIG. 29 is a plan view of a second combined OIS and AF actuator assembly;

FIG. 30 is a side view of the second combined OIS and AF actuator assembly;

FIG. 31A is an exploded projection view of a third combined OIS and AF actuator assembly and FIG. 31B is a projection view of the third combined OIS and AF actuator assembly;

FIG. 32 schematically illustrates the third combined OIS and AF actuator assembly;

FIG. 33 is an exploded projection view of a fourth combined OIS and AF actuator assembly;

FIG. 34 is a projection view of the fourth combined OIS and AF actuator assembly;

FIG. 35 schematically illustrates the fourth combined OIS and AF actuator assembly;

FIG. 36 is an exploded projection view of a fifth combined OIS and AF actuator assembly;

FIG. 37 is a projection view of the fifth combined OIS and AF actuator assembly;

FIG. 38 is a plan view of a flexure bearing included in the fifth combined OIS and AF actuator assembly;

FIGS. 39A and 39B are plan views of bearings of a sixth combined OIS and AF actuator assembly, FIG. 39C is a plan view of a first part of the sixth combined OIS and AF actuator assembly;

FIG. 40 is an exploded projection view of the sixth combined OIS and AF actuator assembly;

FIG. 41 is a projection view of the sixth combined OIS and AF actuator assembly;

FIG. 42 schematically illustrates the sixth combined OIS and AF actuator assembly;

FIGS. 43A and 43B are plan views of tilt resistant bearings for the sixth combined OIS and AF actuator assembly;

FIGS. 44A, 44B and 44C are plan views of alternative bearings for the sixth combined OIS and AF actuator assembly;

FIG. 45 is an exploded projection view of a seventh combined OIS and AF actuator assembly;

FIG. 46 a projection view of the seventh combined OIS and AF actuator assembly;

FIG. 47 schematically illustrates the seventh combined OIS and AF actuator assembly;

FIG. 48 is a cross-section of an eighth combined OIS and AF actuator assembly;

FIG. 49 is a plan view of the eighth combined OIS and AF actuator assembly; and

FIGS. 50A and 50B show a bearing arrangement formed from sheet material.

### DETAILED DESCRIPTION

In the following, like parts are denoted by like reference numerals.

Camera

Referring to FIG. 1, a camera 1 incorporating an SMA actuator assembly 2 (herein also referred to as an “SMA actuator” or simply an “actuator”) is shown.

The camera 1 includes a first part in the form of a lens assembly 3 suspended on a second part in the form of a support structure 4 by the SMA actuator assembly 2. The SMA actuator assembly 2 supports the lens assembly 3 in a manner allowing one or more movements (or degrees-of-freedom) of the lens assembly 3 relative to the support structure 4. The lens assembly 3 has an optical axis O.

The second part in the form of the support structure 4 includes a base 5. An image sensor 6 is mounted on a front side of the base 5. On a rear side of the base 5 (i.e. the base 5 is interposed between the lens assembly 3 and the rear side), there is mounted an integrated circuit (IC) 7 in which a control circuit is implemented, and also a gyroscope sensor (not shown). The support structure 4 also includes a can 8 which protrudes forwardly from the base 5 to encase and protect the other components of the camera 1.

The first part in the form of the lens assembly 3 includes a lens carriage 9 in the form of a cylindrical body supporting two lenses 10 arranged along the optical axis O. In general, any number of lenses 10 may be included. Preferably, each lens 10 has a diameter of up to about 30 mm. The camera 1 can therefore be referred to as a miniature camera.

The lens assembly 3 is arranged to focus an image onto the image sensor 6. The image sensor 6 captures the image and may be of any suitable type, for example, a charge-coupled device (CCD) or a complementary metal-oxide-semiconductor (CMOS) device.

The lenses 10 are supported on the lens carriage 9 and the lens carriage 9 is supported by the SMA actuator assembly 2 such that the lens assembly 3 is movable along the optical axis O relative to the support structure 4, for example to provide focussing or zoom. Although all the lenses 10 are fixed to the lens carriage 9 in this example, in general, one or more of the lenses 10 may be mounted to a component other than the lens carriage 9, and may be fixed in place relative to the image sensor 6, leaving at least one of the lenses 10 attached to the lens carriage and movable along the optical axis O relative to the image sensor 6.

In general, the lens assembly 3 may be moved orthogonally to the optical axis O in use, relative to the image sensor 6, with the effect that the image on the image sensor 6 is moved. For example, if a set of right-handed orthogonal axes x, y, z is aligned so that a third, primary axis z is oriented substantially parallel to the optical axis O, then the lens assembly 3 may be moveable in a direction parallel to the first x axis and/or in a direction parallel to the second y axis. This is used to provide optical image stabilization (OIS), compensating for movement of the camera 1, which may be caused by hand shake etc. The movement providing OIS need not be constrained to the x-y plane. Additionally or alternatively, OIS functionality may be provided by tilting the lens assembly 3, or both the lens assembly 3 and the image sensor 6, about an axis parallel to the first axis x and/or about an axis parallel to the second y axis. Additionally, the lens assembly 3, or at least one lens 10 thereof, may be moved parallel to the optical axis O (along/parallel to the primary axis z) to provide focussing of an image formed on the image sensor 6, for example as part of an automatic focussing (AF) function.

This specification is concerned with examples of SMA actuator assemblies 2 which provide a combination of automatic focussing (AF) and optical image stabilisation (OIS) that is based on lateral (x-y) shifts of the lens assembly 3 relative to the image sensor 6.

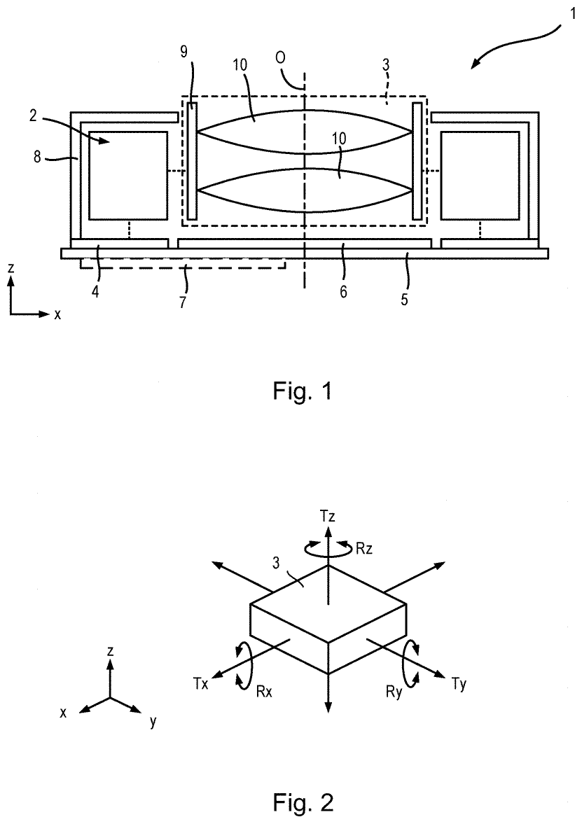

Referring also to FIG. 2, possible types of movement (or degrees-of-freedom) which may be provided by an SMA actuator assembly 2 are illustrated.

A first degree-of-freedom (DOF) Tx corresponds to movement parallel to (along) the first axis x. A second DOF Ty corresponds to movement parallel to (along) the second axis y. A third DOF Tz corresponds to movement parallel to (along) the primary axis z, which is oriented substantially parallel to the optical axis O.

The third DOF Tz corresponds to movement of the lens assembly 3 towards or away from the image sensor 6. The first, second and primary axes x, y, z form a right-handed Cartesian coordinate system. A fourth DOF Rx corresponds to rotation about an axis parallel to the first axis x. A fifth DOF Ry corresponds to rotation about an axis parallel to the second axis y. A sixth DOF Rz corresponds to rotation about an axis parallel to the primary axis z. In some examples, one or more of the axes may be attached to (and move and/or rotate/tilt with) a first part, a second part, or any other elements of an SMA actuator assembly 2 or camera 1. For example, an origin may be an element of the camera 1 such as the image sensor 6 or a lens 10 of the lens assembly 3.

Motions of the lens assembly 3 relative to the support structure 4 may be broken down into components of any or all of the first to sixth DOF (movements) Tx, Ty, Tz, Rx, Ry, Rz. Although described as degrees-of-freedom, in some cases translations and rotations may be linked. For example, a given translation Tz along the primary axis z may be tied to a corresponding rotation Rz so that motion of the lens assembly 3 is helical. Such linked motions may be referred to using a pair enclosed in square brackets to avoid confusion with more independent motions, for example [Tz, Rz] will denote a helical motion as described hereinafter.

This specification concerns SMA actuator assemblies 2 which provide relative movements of the first part relative to the second part along (or parallel to) the first, second and/or primary axes x, y, z. Relative movement of the first part towards or away from the second part along the primary axis z may be a simple translation, or may be in the form of a helical motion linking translation along the primary axis z to rotation about the primary axis z. The movements Tx, Ty along first and second axes x, y provide the OIS functionality herein, whilst motions Tz along, or along an about [Tz, Rz], the primary axis z provide AF functionality. Other motions are constrained by the SMA actuator assemblies 2 described herein.

Shape-Memory Alloy Drive Assemblies

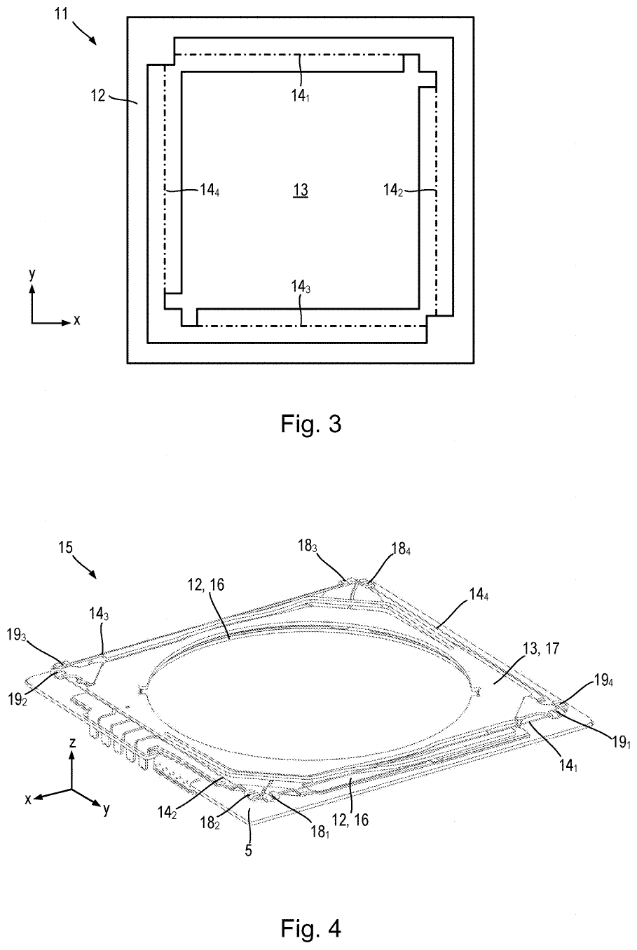

Referring also to FIG. 3, a first type of drive arrangement 11 (first drive arrangement) which may be included in SMA actuator assemblies 2 is shown schematically.

The first drive arrangement 11 includes a first structure 12 and a second structure 13. The second structure 13 is generally supported within a boundary defined by the first structure 12, for example using one or more bearings as described hereinafter. The second structure 12 generally need not provide a complete or uninterrupted boundary. The first and second structures 12, 13 may take the form of respective patterned sheets of metal, e.g., etched or machined stainless steel, and may be coated with an electrically-insulating dielectric material.

Four lengths of shape memory alloy (SMA) wire 14₁, 14₂, 14₃, 14₄ (chained lines) form a loop around the second structure 13. For brevity, lengths of SMA wire shall hereinafter be referred to primarily as “SMA wires”. First 14₁ and third 14₃ SMA wires extend substantially parallel to the first axis x and are spaced apart in a direction parallel to the second axis y. Contraction of the first SMA wire 14₁ will exert a force on the second structure 13 in the negative −x direction, whereas contraction of the third SMA wire 14₃ will exert a force on the second structure 13 in the positive +x direction. Second 14₂ and fourth 14₄ SMA wires extend substantially parallel to the second axis y and are spaced apart in a direction parallel to the first axis x. Contraction of the second SMA wire 14₂ will exert a force on the second structure 13 in the negative −y direction, whereas contraction of the fourth SMA wire 14₄ will exert a force on the second structure 13 in the positive +y direction.

Other examples configurations may be used, and further details are provided in WO 2017/055788 A1 and WO 2019/086855 A1, which are both incorporated herein in their entirety by this reference.

The position of the second structure 13 relative to the first structure 12 perpendicular to the optical axis O is controlled by selectively varying the temperatures of the SMA wires 14₁, 14₂, 14₃, 14₄. This is achieved by passing selective drive signals through the SMA wires 14₁, 14₂, 14₃, 14₄ that provide resistive heating. Heating is provided directly by the drive current. Cooling is provided by reducing or ceasing the drive current to allow the SMA wires 14₁, 14₂, 14₃, 14₄ to cool by conduction, convection and radiation to its surroundings.

In operation, the SMA wires 14₁, 14₂, 14₃, 14₄ are selectively driven to move the second structure 13 relative to the first structure 12 (or vice versa) in any lateral direction (i.e., a direction within a plane parallel to first and second axes x, y and perpendicular to the optical axis O and primary axis z).

Further details are also provided in WO 2013/175197 A1, which is incorporated herein by this reference.

Taking the example of the set of four SMA wires 14₁, 14₂, 14₃, 14₄, the SMA wires 14₁, 14₂, 14₃, 14₄ have an arrangement in a loop at different angular positions around the optical axis O (corresponding here to the primary axis z) to provide two pairs of opposed SMA wires 14₁ & 14₃, 14₂ & 14₄ that are substantially perpendicular to each other. Thus, each pair of opposed SMA wires 14₁ & 14₃, 14₂ & 14₄ is capable on selective driving of moving the second structure 13 in one of two perpendicular directions orthogonal to the optical axis O. As a result, the SMA wires 14₁, 14₂, 14₃, 14₄ are capable of being selectively driven to move the second structure 13 relative to the first structure 12 to any position in a range of movement in a plane orthogonal to the optical axis O. Another way to view this movement is that contraction of any pair of adjacent SMA wires (e.g. SMA wires 14₃, 14₄) will move the second structure 13 in a direction bisecting the pair of SMA actuator wires (diagonally in FIG. 3). Another way to view this movement is that contraction of any pair of adjacent SMA wires (e.g. SMA wires 14₃, 14₄) will move the second structure 13 in a direction bisecting the pair of SMA actuator wires (diagonally in FIG. 3). Moreover, the SMA wires 14₁, 14₂, 14₃, 14₄ are capable of being actuated to generate torque about an axis parallel to the primary axis z. In particular, contraction of one pair of opposite SMA wires (e.g. SMA wires 14₁, 14₃) will produce a torque on the second structure 13 in one sense about an axis parallel to the primary axis z, and contraction of the other pair of opposite SMA wires (e.g. SMA wires 14₂, 14₄) will produce a torque in the other sense. The generation of torque and a resulting rotation may be substantially independent of the translations along directions parallel to the first and/or second axes x, y, at least over a part of the range of motion of the drive arrangement 11. The magnitude of the range of movement depends on the geometry and the range of contraction of the SMA wires 14₁, 14₂, 14₃, 14₄ within their normal operating parameters.

On heating of one of the SMA wires 14₁, 14₂, 14₃, 14₄, the stress in the SMA wire 14₁, 14₂, 14₃, 14₄ increases and it contracts, causing movement of the second structure 13 relative to the first structure 12. A range of movement occurs as the temperature of the SMA increases over a range of temperature in which there occurs the transition of the SMA material from the Martensitic phase to the Austenitic phase. Conversely, on cooling of one of the SMA wires 14₁, 14₂, 14₃, 14₄ so that the stress in the SMA wire 14₁, 14₂, 14₃, 14₄ decreases, it expands under the force from opposing ones of the SMA wires 14₁, 14₂, 14₃, 14₄ (and in some examples also biasing forces from one or more biasing means such as springs, armatures and so forth). This allows the second structure 13 to move in the opposite direction relative to the first structure 12.

The SMA wires 14₁, 14₂, 14₃, 14₄ may be made of any suitable SMA material, for example Nitinol or another titanium-alloy SMA material.

The drive signals for the SMA wires 14₁, 14₂, 14₃, 14₄ are generated and supplied by the control circuit implemented in the IC 7. For example, if the first structure 12 is fixed to (or part of) the support structure 4 and the second structure 13 is fixed to (or part or) the lens assembly 3, then the drive signals are generated by the control circuit in response to output signals of the gyroscope sensor (not shown) so as to drive movement of the lens assembly 3 to stabilise an image focused by the lens assembly 3 on the image sensor 6, thereby providing OIS. The drive signals may be generated using a resistance feedback control technique, for example as described in WO 2014/076463 A1, which is incorporated herein by this reference.

Each of the SMA wires 14₁, 14₂, 14₃, 14₄ corresponds to a length of shape memory alloy wire over which a drive current may be controlled independently. A pair of lengths of shape memory alloy wire may be provided by a single physical wire having a first current source connected to one end, a second current source connected to the other end and a current return connection at a point between the two ends. For example, in the first drive arrangement 11, the first and second SMA wires 14₁, 14₂ may be provided by a single physical wire, with a current return provided through the second structure 13.

Referring also to FIG. 4, an example of a “flat” SMA actuator assembly 15 implementing the first drive arrangement 11 is shown.

In the flat actuator assembly 15 the first structure 12 takes the form of a flat, annular plate 16 having a rectangular outer perimeter (or “outer edge”) and a circular inner perimeter (or “inner edge”), whilst the second structure 13 takes the form of a flat, thin annular sheet 17 with a rectangular outer perimeter and a circular inner perimeter. The first structure 12 in the form of the plate 16 is supported on a base 5 in the form of a rectangular plate. The four SMA wires 14₁, 14₂, 14₃, 14₄ are each attached at one end to respective first crimps 18₁, 18₂, 18₃, 18₄ (also referred to as “static” crimps) which are fixedly attached to (or formed as part of) the first structure 12, 16. The other end of each SMA wire 14₁, 14₂, 14₃, 14₄ is attached to a respective second crimp 19₁, 19₂, 19₃, 19₄ (also referred to as a “moving” crimp) which is fixedly attached to (or formed as part of) the second structure 13, 17.

The plate 16 and the sheet 17 may each take the form of respective patterned sheets of metal, e.g., etched or machined stainless steel, and may be coated with an electrically-insulating dielectric material. The plate 16 and the sheet 17 are each provided with a respective central aperture aligned with the optical axis O allowing the passage of light from a lens assembly 3 mounted to the sheet 17 to an image sensor 6 supported on the base 5.

The four SMA wires 14₁, 14₂, 14₃, 14₄ may be perpendicular to the optical axis O or inclined at a small angle to a plane perpendicular to the optical axis O. Generally, in a set, the four SMA wires 14₁, 14₂, 14₃, 14₄ are non-collinear.

The flat actuator assembly 15 includes a number of plain bearings (not shown in FIG. 4) spaced around the optical axis O to bear the second structure 13, 17 on the first structure 12, 16. Preferably, at least three bearings are used in order to assist in providing stable support, although in general, a different number of bearings may be used. Each plain bearing (not shown in FIG. 4) may take the form of a bearing member in the form of cylinder, and may be attached to, or formed as part of, the first structure 12. The plain bearings (not shown in FIG. 4) may be made from a suitable metal or alloy such as phosphor bronze or stainless steel with a diamond-like carbon coating. The plain bearings (not shown in FIG. 4) may be made from, or may include an upper layer or coating of, a polymer such as Polyoxymethylene (POM, Acetal), Polytetrafluoroethylene (PTFE), or PTFE impregnated POM. The plain bearings (not shown in FIG. 4) may be made from, or may include an upper layer or coating of Stainless steel or phosphor bronze with coatings of Titanium Carbide, Tungsten Carbon Carbide, Diamond Like Coating (DLC), Chromium Carbide DLC. These bearing materials may interface with a second bearing surface formed of one of these bearing materials, which could be polished or stamped to reduce the effects of friction generated by surface texture.

The flat actuator assembly 15 will generally also include biasing means (not shown) such as one or more springs or flexure arms arranged and configured to maintain the first and second structures 12, 13 in contact (via the plain bearings) and/or to urge the first and second structures 12, 13 towards a neutral (for example central) relative position when the SMA wires 14₁, 14₂, 14₃, 14₄ are not powered.

Details relevant to manufacturing actuator assemblies similar to the flat actuator assembly 15 can be found in WO 2016/189314 A1 which is incorporated herein in its entirety this reference.

Although not shown in FIG. 4, the flat actuator assembly 15 may be provided with end stops to provide limits on lateral movement of the second structure 13 relative to the first structure 12. In this way, the SMA wires 14₁, 14₂, 14₃, 14₄ can be protected from overextension resulting from, for example, impacts to which a device (not shown) incorporating the flat actuator assembly 15 may be subjected (for example being dropped).

As described hereinbefore, the first drive arrangement 11 can drive translations Tx, Ty along first and/or second axes x, y and rotations Rz about an axis parallel to the primary axis z (which is substantially parallel to the optical axis O). Each of these motions Tx, Ty, Rz is substantially independent of the others, at least over a part of a range of motion of the first drive arrangement. However, in order to provide translation Tz parallel to the primary axis z, the first drive arrangement 11 must be combined with at least one bearing capable of converting a torque applied about the optical axis O into a combination of rotation Rz and translation Tz (a helical movement [Tz, Rz] as described hereinafter).

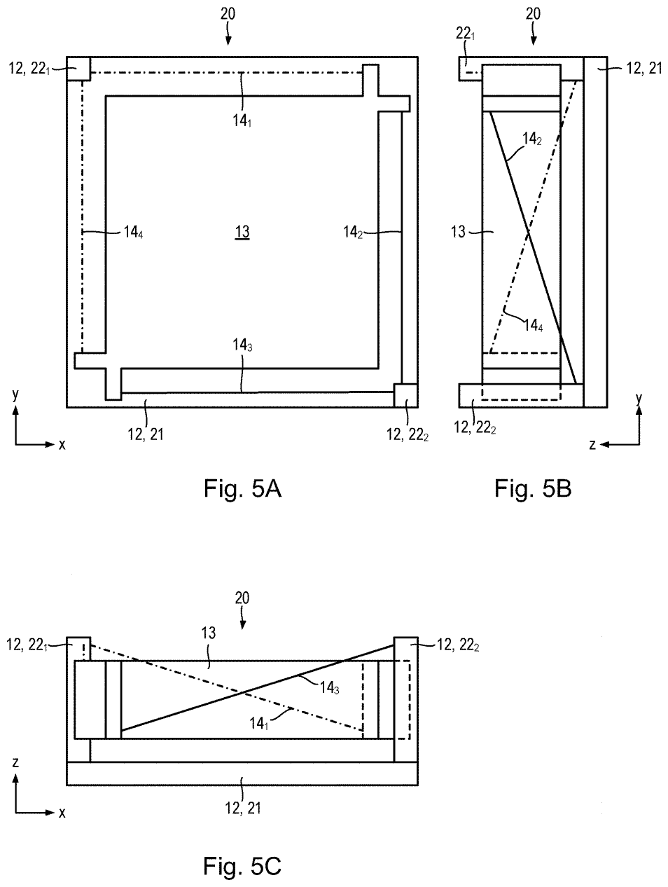

Referring also to FIGS. 5A to 5C, a second type of drive arrangement 20 which may be included in SMA actuator assemblies 2 is shown schematically.

The second drive arrangement 20 is similar to the first drive arrangement 11 except that the first structure 12 includes a base 21 and a pair of first and second upstanding pillars 22₁, 22₂, and that the SMA wires 14₁, 14₂, 14₃, 14₄ are not substantially confined to a plane perpendicular to the primary axis z.

FIG. 5A shows the second drive arrangement 20 viewed from above, along a direction parallel to the primary axis z.

FIG. 5B shows the second drive arrangement 20 viewed from the side, along a direction parallel to the first axis x. Note that the fourth SMA wire 14₄ has been superimposed on FIG. 5B for visual purposes, even though the fourth SMA wire 14₄ would be largely obscured behind the second structure 13.

FIG. 5C shows the second drive arrangement 20 viewed from the side, along a direction parallel to the second axis y. Note that the first SMA wire 14₁ has been superimposed on FIG. 5B for visual purposes, even though the first SMA wire 14₁ would be largely obscured behind the second structure 13.

The base 21 extends beyond the edges of the second structure 13 when viewed along the primary axis (FIG. 5A), and in this example is rectangular (or square). The first pillar 22₁ is upstanding from a first corner of the base 21, and the second pillar 22₂ is upstanding from a second corner, diagonally opposite across the second structure 13.

The first SMA wire 14₁ connects from a lower portion (lower along the primary axis z) of the second structure 13 to an upper portion (higher along the primary axis z) of the first pillar 22₁. The second SMA wire 14₂ connects from an upper portion of the second structure 13 to a lower portion of the second pillar 22₂. The third SMA wire 14₃ connects from a lower portion of the second structure 13 to an upper portion of the second pillar 22₂. The fourth SMA wire 14₂ connects from an upper portion of the second structure 13 to a lower portion of the first pillar 22₁.

In this way, the first SMA wire 14₁ opposes the third SMA wire 14₃ in a direction parallel to the first axis x, the second SMA wire 14₂ opposes the fourth SMA wire 14₄ in a direction parallel to the second axis y, and the first and third SMA wires 14₁, 14₃ oppose the second and fourth SMA wires 14₂, 14₄ in a direction parallel to the primary axis z.

In this way, the second drive arrangement 20, using four angled (non-coplanar) SMA wires 14₁, 14₂, 14₃, 14₄, may provide drive corresponding to Tx, Ty, Tz, Rx, Ry, Rz motions. The motions are not fully independent degrees of freedom, and in general translations will be linked to rotations, for example [Tx, Rx], [Ty, Ry] and [Tz, Rz], with the specific couplings depending on the angles of the SMA wires 14₁, 14₂, 14₃, 14₄.

The SMA wires 14₁, 14₂, 14₃, 14₄ are preferably inclined at an angle of between 10 and 25° relative to a plane perpendicular to the primary axis z.

Either or both of the first structure 12, 21 and the second structure 13 may include central apertures to permit light from a lens assembly 3 to form an image on an image sensor 6.

One of more of the motions driven by the first or second drive arrangements 11, 20 may be fully or partly constrained by mechanically coupling one or more bearings between the first and second structures 12, 13.

Bearings

In general, a SMA actuator 2 according to this specification will include at least one of the first and second drive arrangements 11, 20 and also an arrangement of one or more mechanical bearings (also referred to as a “bearing arrangement”) serving to support, constrain and/or convert the movements generated by the first or second drive arrangement 11, 20.

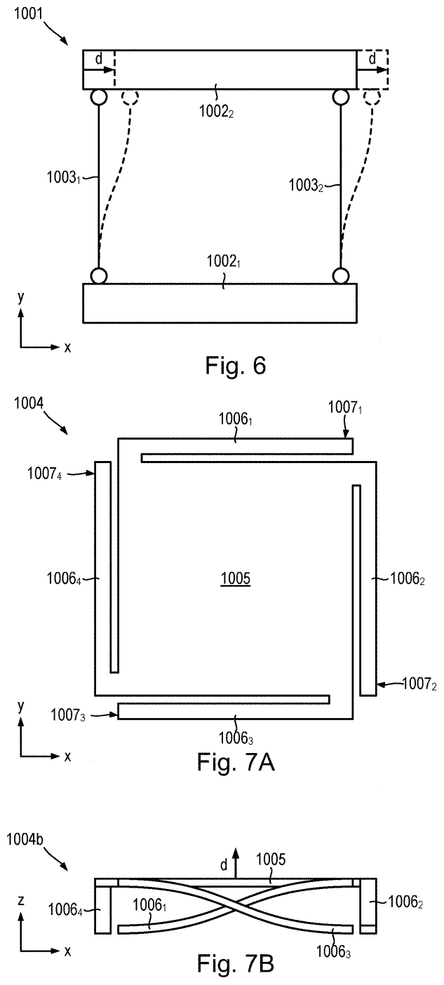

Referring also to FIG. 6, a two-bar link bearing 1001 is shown.

The two-bar link bearing 1001 includes first and second rigid portions 1002₁, 1002₂ connected by first and second beam portions 1003₁, 1003₂ (also referred to as flexures) The rigid portions 1002₁, 1002₂ are each elongated in a direction parallel to the first axis x, and are spaced apart from one another in a direction parallel to the second axis y. The beam portions 1003₁, 1003₂ are each elongated in a direction parallel to the second axis y, and are spaced apart from one another in a direction parallel to the first axis x. The beam portions 1003₁, 1003₂ are shown as being perpendicular to the rigid portions 1002₁, 1002₂, however this is not essential and any angle will work provided that the beam portions 1003₁, 1003₂ are parallel to one another. The beam portions 1003₁, 1003₂ are unable to rotate about the joints with the rigid portions 1002₁, 1002₂, for example the connections are not pin-jointed or similar.

The relative flexural rigidities of the beam portions 1003₁, 1003₂ and the rigid portions 1002₁, 1002₂ are selected (primarily using the dimensions and shapes of cross-sections) so that if the first rigid portion 1002₁ is clamped, the second rigid portion 1002₂ may move relative to the first rigid portion 1002₁ via bending of the beam portions 1003₁, 1003₂ in the x-y and/or x-z planes. In this way, the two-bar link 1001 is able to provide for relative movements Tx, Tz, Rx and Ry between the first and second rigid portions 1002₁, 1002₂. A deformed state in which the second rigid portion 1002₂ is displaced by a distance d parallel to the first axis is also shown in FIG. 6 using dashed lines. The two-bar link bearing 1001 may be rotated 90 degrees to provide movement Ty parallel to the second axis y instead of Tx.

The relative resistance to bending in x-y versus y-z planes may be controlled by using the cross-sectional shape of the beam portions 1003₁, 1003₂ to select relative flexural rigidities.

Referring also to FIG. 7A, a tiltable z-flexure in the form of a two-by-two parallel bar link bearing 1004 (also referred to as a simple flexure) is shown.

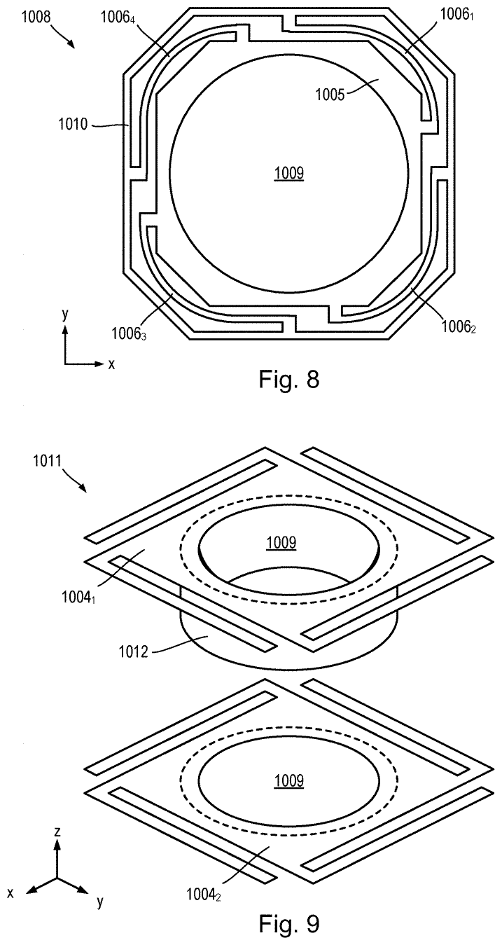

The simple flexure 1004 includes a central portion 1005 and two pairs of beam portions (or flexures) 1006₁, 1006₂, 1006₃, 1006₄. Each beam portion (or flexure) 1006₁, 1006₂, 1006₃, 1006₄ is rigidly connected to the central portion 1005 at one end, and has a second, free end 1007₁, 1007₂, 1007₃, 1007₄. In some examples the central portion 1005 may also have a central aperture 1009 (FIG. 8). The first and third beam portions (flexures) 1006₁, 1006₃ are elongated in a direction parallel to the first axis x, and are able to deform by beam bending in the x-z plane. Similarly, the second and fourth beam portions (flexures) 1006₂, 1006₄ are elongated in a direction parallel to the second axis y, and are able to deform e.g. by beam bending in the y-z plane. Deflection of beam portions (or flexures) 1006₁, 1006₂, 1006₃, 1006₄ laterally (perpendicular to the primary axis z) is constrained by the connection of all the beam portions (or flexures) 1006₁, 1006₂, 1006₃, 1006₄ to the central portion 1005 and/or by the cross-sectional shapes of the beam portions 1006₁, 1006₂, 1006₃, 1006₄.

In this way, if the free ends 1007 are clamped, the simple flexure 1004 is able to provide for relative movements Tz, Rx and/or Ry between the central portion 1005 and the clamped free ends 1007.

Referring also to FIG. 7B, a deformed state 1004b of the simple flexure of FIG. 7A is shown in which the central portion 1005 is displaced by a distance d parallel to the primary axis z.

Referring also to FIG. 8, a second simple flexure (tiltable z-flexure) 1008 is shown.

The second simple flexure 1008 is the same as the simple flexure 1004, except that the central portion 1005 includes a central aperture 1009, that the ends of the beam portions 1006₁, 1006₂, 1006₃, 1006₄ not connected to the central portion 1005 are connected to an outer annulus 1010, and that the beam portions 1006₁, 1006₂, 1006₃, 1006₄ are curved instead of straight. The second simple flexure 1008 functions in substantially the same way as the simple flexure 1004. In particular, if the outer annulus is clamped, then the central portion 1005 may move in Tz, Rx and/or Ry.

The presence or absence of a central aperture 1009 in the second simple flexure 1008 or the simple flexure 1004 may depend on the position within a device, for example the camera 1. A simple flexure 1004, 1008 located below the image sensor 6 will not generally require a central aperture 1009, whereas a simple flexure 1004, 1008 located above the image sensor 6 will generally require a central aperture 1009.

Referring also to FIG. 9, a z-flexure 1011 is shown.

The z-flexure includes a pair of simple flexures 1004₁, 1004₂ disposed perpendicular to the primary axis z (when not deformed), and spaced apart in a direction parallel to the primary axis z by a rigid structure 1012 sandwiched between the pair of simple flexures 1004₁, 1004₂. The simple flexures 1004₁, 1004₂ are fixed to opposed faces of the rigid structure 1012. The simple flexures 1004₁, 1004₂ each include a central aperture 1009. The illustration in FIG. 9 shows the rigid structure 1012 fixed to one of the simple flexures 1004₁ and detached from the other simple flexure 1004₂ for visual purposes, though in use both simple flexures 1004₁, 1004₂ are fixed to the rigid structure 1012. Dashed lines in FIG. 9 illustrate the projected outline of the rigid structure 1012.

In this way, each individual beam portion 1006 of each simple flexure 1004₁, 1004₂ may deflect. However, the separation of the simple flexures 1004₁, 1004₂ in a direction parallel to the primary axis z and the fixed connection via the rigid structure 1012 constrains movements Tx, Ty, Rx, Ry, Rz whilst guiding movement Tz in a direction parallel to the primary axis z.

In this example the rigid structure 1012 is a hollow cylinder having an inner diameter equal to the diameter of the central apertures 1009. However, the rigid structure 1012 may have any shape suitable for spacing the simple flexures apart parallel to the primary axis z and compatible with an intended application of an actuator.

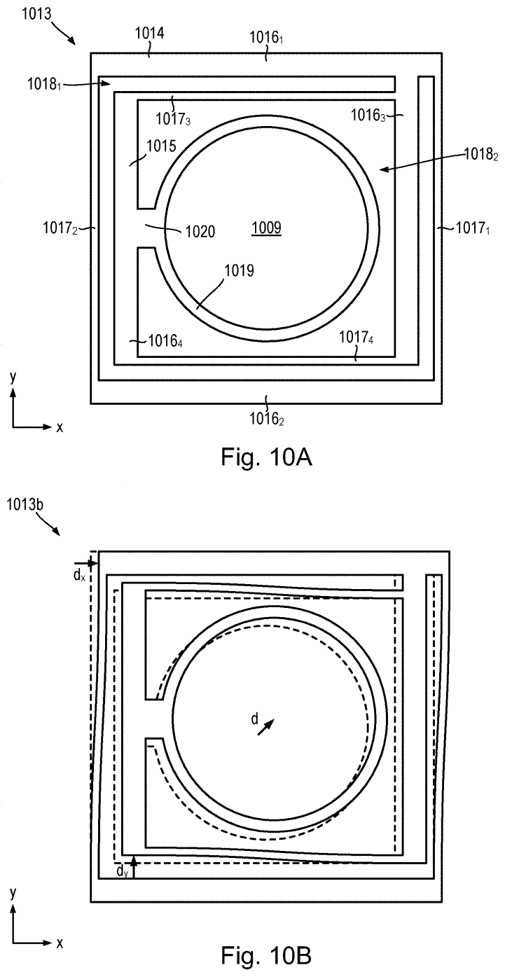

Referring also to FIG. 10A, a first example of a non-rotating general bearing 1013 (also referred to as a “two-by-two-bar link”) is shown.

The first non-rotating general bearing 1013 includes an outer two-bar link 1014 which is mechanically in series with an inner two-bar link 1015. The outer two bar link 1014 is formed from first and second rigid portions 1016₁, 1016₂ elongated in a direction parallel to the first axis x and connected together in a direction parallel to the second axis y using first and second beam portions (flexures) 1017₁, 1017₂. The inner two-bar link 1015 is formed from third and fourth rigid portions 1016₃, 1016₄ elongated in a direction parallel to the second axis y and connected together in a direction parallel to the first axis x using third and fourth beam portions (flexures) 1017₃, 1017₄. The inner two-bar link 1015 is connected to the outer two bar link 1014 using the third rigid portion 1016₃ which connects directly to the first rigid portion 1016₁. With the exception of this connection, the inner two-bar link 1015 is separated from the outer two-bar link 1014 by a first gap 1018₁ which provides space for lateral deflection of the first and second beam portions 1017₁, 1017₂. A central annular portion 1019 is located within the inner two-bar link 1015 and connected to the fourth rigid portion 1016₄ by a rigid connecting portion 1020. Aside from the rigid connecting portion 1020, the central annular portion 1019 is separated from the inner two-bar link 1015 by a second gap 1018₂ providing space for lateral deflection of the third and fourth beam portions 1017₃, 1017₄. The central annular portion 1019 defines a central aperture 1009.

The difference between “rigid” and “beam” portions in this specification is not absolute and is determined by relative flexural rigidity as defined e.g. by the respective cross-sectional areas. Beam portions are less resistant to bending, at least in the desired directions, than rigid portions.

Referring also to FIG. 10B, a deformed configuration 1013b of the first non-rotating general bearing 1013 is shown.

If the second rigid portion 1016₂ is clamped, then bending of the first and second beam portions 1017₁, 1017₂ permits movements Tx, Tz in directions substantially parallel to the first x and/or primary axes z, as well as rotations Rx, Ry about first x and/or second y axes. Similarly, relative to the third rigid portion 1016₃, the fourth rigid portion 1016₄ and connected central annular portion 1019 permits movements corresponding to Ty, Tz, Rx and/or Ry. Overall, this permits motion of the central annular portion 1019 relative to the clamped second rigid portion 1016₂ corresponding to Tx, Ty, Tz, Rx and/or Ry, and constraining only rotation Rz about the primary axis z. For example, FIG. 10B illustrates a relative displacement d of the central annular portion 1019 relative to the second rigid portion 1016₂ having a component dₓ parallel to the first axis x and a component d_{y} parallel to the second axis y.

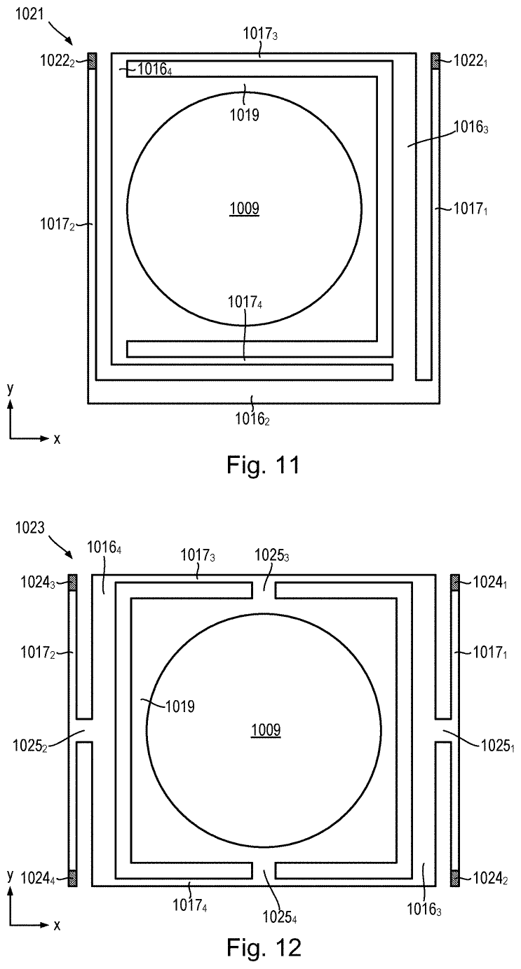

Referring also to FIG. 11, a second example of a non-rotating general bearing 1021 (second two-by-two-bar link) is shown.

The second non-rotating general bearing 1021 is the same as the first non-rotating general bearing 1013, except that the first rigid portion 1016₁ is omitted, the third rigid portion 1016₃ is connected to the second rigid portion 1016₂, and the central annular portion 1019 is directly integrated with the fourth rigid portion 1016₄ so as to omit the rigid connecting portion 1020. The respective free ends 10221, 10222 of the first and second beam portions 1017₁, 1017₂ may be clamped, and relative motion of the central annular portion 1019 corresponding to Tx, Ty, Tz, Rx and/or Ry is possible.

Referring also to FIG. 12, a third example of a non-rotating general bearing 1023 (third two-by-two-bar link) is shown.

The third non-rotating general bearing 1023 functions similarly to the first and second non-rotating general bearings 1013, 1021, however, both first and second rigid portions 1016₁, 1016₂ are omitted. The first beam portion 1017₁ extends between first and second free ends 1024₁, 1024₂, and is connected at its centre to the centre of the third rigid portion 1016₃ by a first rigid connecting portion 10251. Similarly, the second beam portion 1017₂ extends between third and fourth free ends 1024₃, 1024₄, and is connected at its centre to the centre of the fourth rigid portion 1016₄ by a second rigid connecting portion 10252. The central annular portion 1019 is connected to the third beam portion 1017₃ using a centrally positioned third rigid connecting portion 10253, and connected to the fourth beam portion 1017₄ using a centrally positioned fourth rigid connecting portion 1025₄. In this way, each beam portion 1017 is effectively split into a pair of beam portions either side of the respective rigid connection portion 1025. The free ends 1024 may all be clamped, and relative motion of the central annular portion 1019 corresponding to Tx, Ty, Tz, Rx and/or Ry is possible. The rigid connecting portions 1025 should typically be wide enough to reduce or prevent torsional deformations during expected loading conditions.

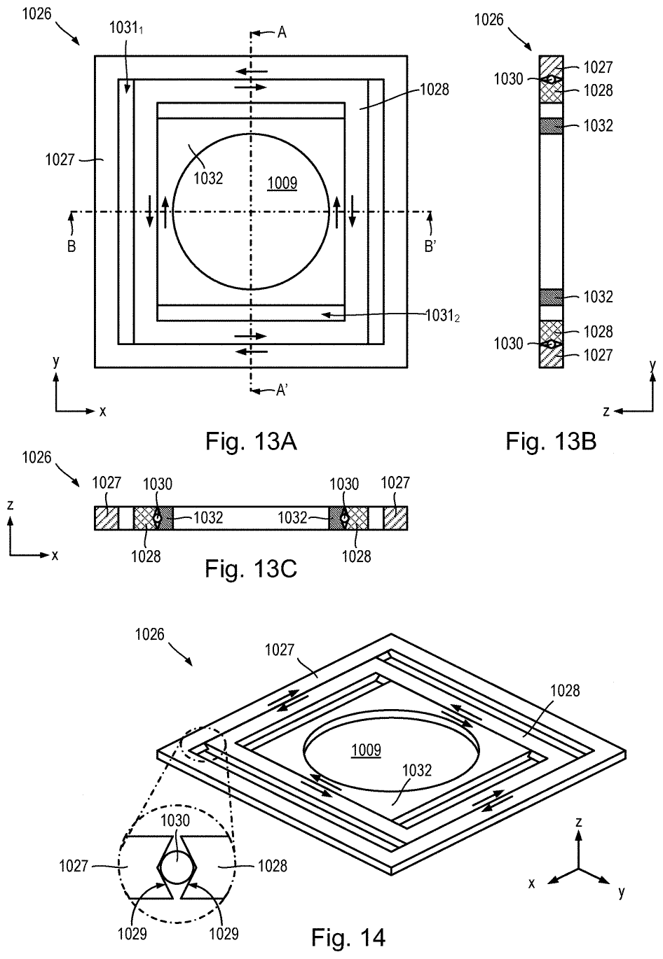

Referring also to FIGS. 13A to 13C and 14, a first x-y bearing 1026 is shown.

FIG. 13A is a top view, FIG. 13B shows a cross-section along the line labelled A-A′, FIG. 13C shows a cross-section along the line labelled B-B′, and FIG. 14 shows a projection view.

The first x-y bearing 1026 takes the form of a pair of nested ball-bearing races oriented perpendicular to one another. A first frame 1027 takes the form of a rectangular annulus. A second frame 1028, also taking the form of a rectangular annulus, is received within the first frame 1027. The interior edges of the first frame 1027 running parallel to the first axis x are formed with a V-shaped channel 1029, and the opposing outer edges of the second frame 1028 are also formed with a V-shaped channel 1029. This may be seen in FIG. 13B and particularly in the inset of FIG. 14. One or more ball bearings 1030 are received into the opposed V-shaped channels 1029 to form a first bearing race which permits movement Tx parallel to the first axis x and constrains all other DOF. Channels with profiles other than V shaped may be used, provided that such profiles will secure the ball bearings 30 within the race. Denoting the inner dimensions of the first frame 1027 as lₓ parallel to the first axis x and l_{y} parallel to the second axis y, and similarly denoting the outer dimensions of the second frame 28 as hₓ, h_{y}, the dimensions satisfy hₓ<lₓ and h_{y} l_{y}. The difference lₓ−hₓ should be large enough to provide a first gap 10311 to permit a desired range of motion parallel to the first axis x.

A central portion 1032 is received within the second frame 1028, and takes the form of a rectangular portion. The central portion 1032 as shown defines a central aperture 1009, but the central aperture 1009 may be omitted if the first x-y bearing 1026 is disposed below/behind an optical path to an image sensor 6. The interior edges of the second frame 1028 running parallel to the second axis y are formed with a V-shaped channel 1029, and the opposing outer edges of the central portion 1032 are also formed with a V-shaped channel 1029. One or more ball bearings 1030 are received into the opposed V-shaped channels 29 to form a second bearing race which permits movement Ty parallel to the second axis y and constrains all other DOF. A second gap 10312 is provided to help define the range of motion parallel to the second axis y.

In this way, the relative movements between the central portion 1032 and the first frame 1027 may correspond to Tx and/or Ty, whilst movement Tz parallel to the primary axis z and all rotations Rx, Ry, Rz are constrained.

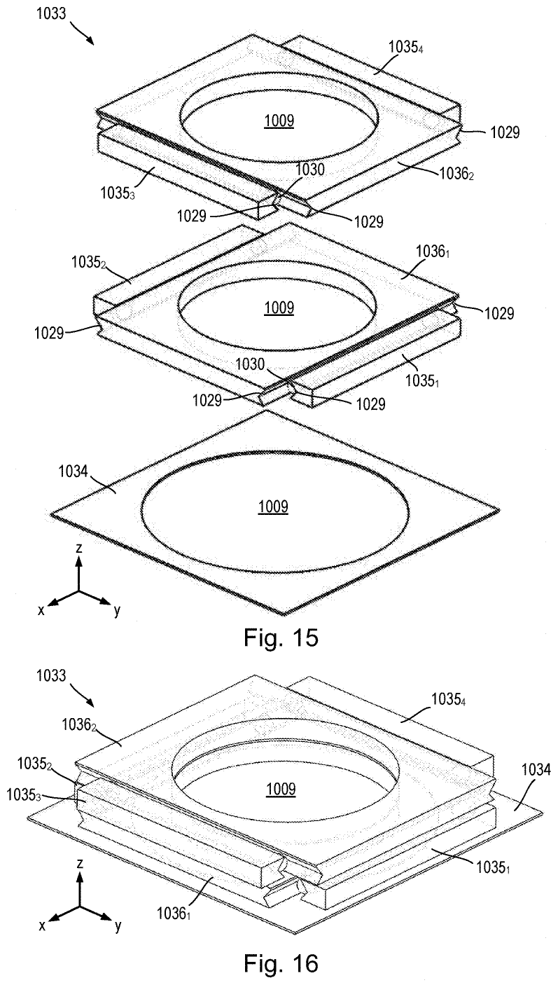

Referring also to FIGS. 15 and 16, a second x-y bearing 1033 is shown.

FIG. 15 shows an exploded projection view and FIG. 16 shows a projection view. Occluded details are drawn using grey and/or dashed lines.

The second x-y bearing 1033 takes the form of a pair of ball-bearing races stacked in a direction parallel to the primary axis z and oriented perpendicular to one another. A base plate 1034 takes the form of an annulus having a rectangular outer perimeter and a circular inner perimeter defining a central aperture 1009. First and second guide portions 10351, 10352 elongated in a direction parallel to the first axis x are fixed to the base plate 1034 on opposite sides of the central aperture 1009. A first stage portion 10361 in the form of a cuboidal block including a central aperture 1009 is received between the first and second guide portions 10351, 10352. The opposed edges of the first stage portion 10361 and the first and second guide portions 10351, 10352 are provided with V-shaped channels 29 to define a first set of ball bearing races which include one or more ball bearings 30 and provide for movement Tx parallel to the first axis x.

Third and fourth guide portions 10353, 10354 elongated in a direction parallel to the second axis y are fixed to the first stage portion 10361 on opposite sides of the central aperture 1009. A second stage portion 10362 in the form of a cuboidal block including a central aperture 1009 is received between the third and fourth guide portions 10353, 10354. The opposed edges of the second stage portion 10362 and the third and fourth guide portions 10353, 10354 are provided with V-shaped channels 29 to define a second set of ball bearing races which include one or more ball bearings 30 and provide for movement Ty parallel to the second axis y.

In this way, the relative movements between the base plate 1034 and the second stage portion 10362 may correspond to Tx and/or Ty, whilst movement Tx parallel to the primary axis z and all rotations Rx, Ry, Rz are constrained.

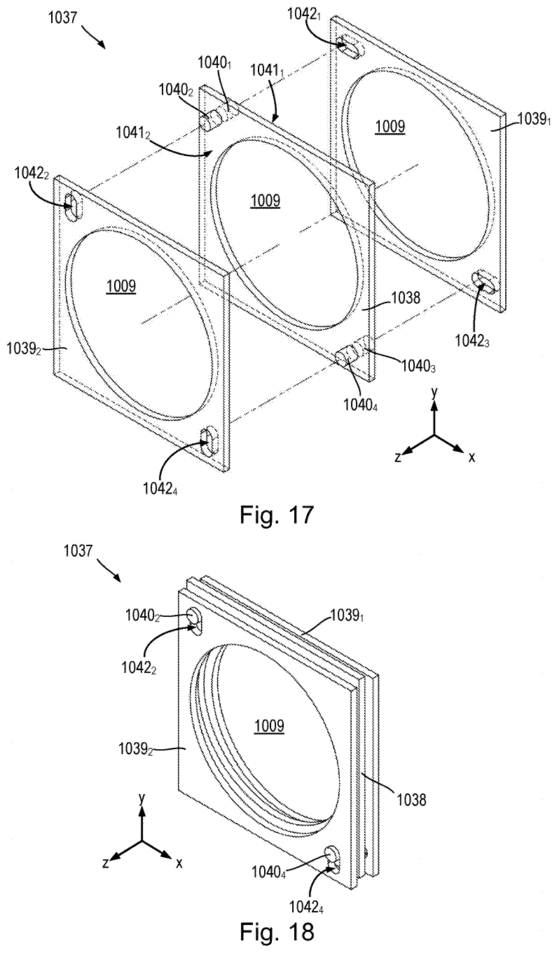

Referring also to FIGS. 17 and 18, a third x-y bearing 1037 is shown.

FIG. 17 shows an exploded projection view and FIG. 18 shows a projection view. Occluded details are drawn using dashed lines.

The third x-y bearing 1037 includes a central plate 1038, a first plate 1039₁ and a second plate 1039₂. Each of the central 1038, first 1039₁ and second plates 1039₂ takes the form of an annulus having a rectangular outer perimeter and a circular inner perimeter defining a respective central aperture 1009. In one corner of the central plate 1038, a first cylindrical protrusion 1040₁ is upstanding from a first face 1041₁ whilst a second protrusion 1040₂ is upstanding from a second face 1041₂ opposed to the first face 1041₁. The first and second cylindrical protrusions 1040₁, 1040₂ are co-axial. In a second corner, diagonally opposite to the first and second cylindrical protrusions 1040₁, 1040₂ across the central aperture 1009, a third cylindrical protrusion 1040₃ is upstanding from the first face 1041₁ whilst a fourth protrusion 1040₄ is upstanding from the second face 1041₂.

When the first plate 1039₁ is stacked with the central plate 1038, the first cylindrical protrusion 1040₁ is received into a first elongated through-hole 1042₁ formed through the first plate 1039₁ and the third cylindrical protrusions 1040₃ is received into a third elongated through-hole 10423 formed through the first plate 1039₁. Similarly, when the second plate 1039₂ is stacked with the central plate 1038, the second cylindrical protrusion 1040₂ is received into a second elongated through-hole 1042₂ formed through the second plate 1039₂ and the fourth cylindrical protrusions 1040₄ is received into a fourth elongated through-hole 1042₄ formed through the second plate 1039₂. The first and third elongated through-holes 1042₁, 1042₃ have a width in a direction parallel to the second axis y which is just wide enough to receive the respective cylindrical protrusion 1040₁, 1040₃, and a length in a direction parallel to the first axis x which is larger than a diameter of the respective cylindrical protrusion 1040₁, 1040₃ so as to permit movement Tx of the first plate 1039₁ relative to the central plate 1038 parallel to the first axis x.

The second and fourth elongated through-holes 1042₂, 1042₄ have a width in a direction parallel to the first axis x which is just wide enough to receive the respective cylindrical protrusion 1040₂, 1040₄, and a length in a direction parallel to the second axis y which is larger than a diameter of the respective cylindrical protrusion 1040₂, 1040₄ so as to permit movement Ty of the second plate 1039₂ relative to the central plate 1038 parallel to the second axis y.

In this way, the relative motions between the first plate 1039₁ and the second plate 1039₂ correspond to Tx and/or Ty, whilst movement Tx parallel to the primary axis z and all rotations Rx, Ry, Rz are constrained.

Biasing means (not shown) urge the first and second plates 1039₁, 1039₂ together to maintain contact with the central plate 1038. Cylindrical protrusions 1040 are preferred but not essential, as protrusions with other shapes will also work. Cylindrical protrusions 1040 are preferably all of the same diameter, but may be different diameters without compromising the functionality of the third x-y bearing. The cylindrical protrusions 1040 may be attached to the central plate 1038 or integrally formed with the central plate 1038.

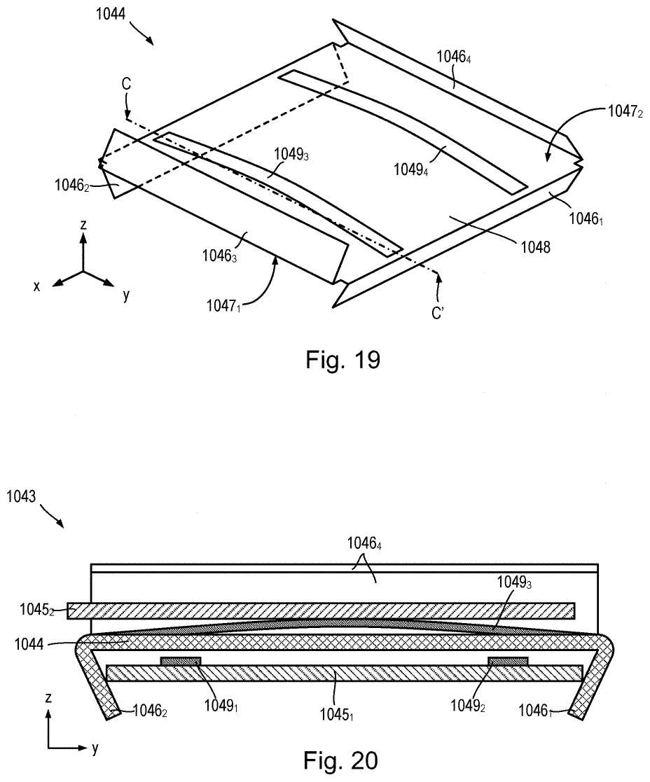

Referring also to FIGS. 19 and 20 a fourth x-y bearing 1043 is shown.

FIG. 19 shows a projection view of a frame portion 1044 of the fourth x-y bearing 1043. Some occluded details are drawn using dashed lines in FIG. 19. FIG. 20 shows a section corresponding the line labelled C-C′ of the fourth x-y bearing 1043, including the frame portion 1044 and first and second sliding portions 1045₁, 1045₂.

The frame portion 1044 is formed from, for example, a cross-shaped section of sheet metal. First and second opposed cross-arms are folded about axes parallel to the first axis x to form first and second tabs 1046₁, 1046₂. The first and second tabs 1046₁, 1046₂ are folded back over a first face 1047₁ of a central portion 1048 of the frame portion 1044, and make angles (preferably the same) of less than 90 degrees with the central portion 1048. Similarly, third and fourth opposed cross-arms are folded about axes parallel to the second axis y to form third and fourth tabs 1046₃, 1046₄ which are folded back over a second face 1047₂ (opposite to the first face) of the central portion 1048 to make angles (preferably the same) of less than 90 degrees with the central portion 1048. First and second springs 1049₁, 1049₂ (FIG. 20) are formed by attaching strips elongated in a direction parallel to the first axis x to the first face 1047₁, with attachment points separated by a distance less than the length of the strips. This causes the strips to bend upwards slightly from the first surface 1047₁ forming the first and second springs 1049₁, 1049₂. Similar third and fourth springs 1049₃, 1049₄ are attached to the second surface 1047₂, but oriented in a direction parallel to the second axis y instead.

To assemble the fourth x-y bearing, the first sliding portion 1045₁ is inserted between the first and second tabs 1046₁, 1046₂ so as to slightly compress the first and second springs 1049₁, 1049₂. The first sliding portion 1045₁ has a width in a direction parallel to the second axis y which is less than a spacing in a direction parallel to the second axis y of the tabs 1046₁, 1046₂ where they join to the central portion 1048, but greater than a spacing of free ends of the tabs 1046₁, 1046₂. The springs 1049₁, 1049₂ urge the first sliding portion 1045₁ against the angled tabs 1046₁, 1046₂ with a force sufficient to retain the first sliding portion 1045₁. However, the first sliding portion 1045₁ may still slide relative to the frame portion 1044 parallel to the first direction x. Similarly, the second sliding portion 1045₂ is inserted between the third and fourth tabs 1046₃, 1046₄ so as to slightly compress the third and fourth springs 1049₃, 1049₄, and may slide parallel to the second direction y.

In this way, the relative motions between the first sliding portion 1045₁ and the second sliding portion 1045₂ correspond to Tx and/or Ty, whilst movement Tx parallel to the primary axis z and all rotations Rx, Ry, Rz are constrained. Although illustrated using angled tabs 1046, the fourth x-y bearing 1043 may use any suitable retaining structures. Although illustrated using springs 1049 in the form of bent strips, any suitable biasing means may be used to urge the sliding portions 1045 against retaining features of the frame portion 1044.

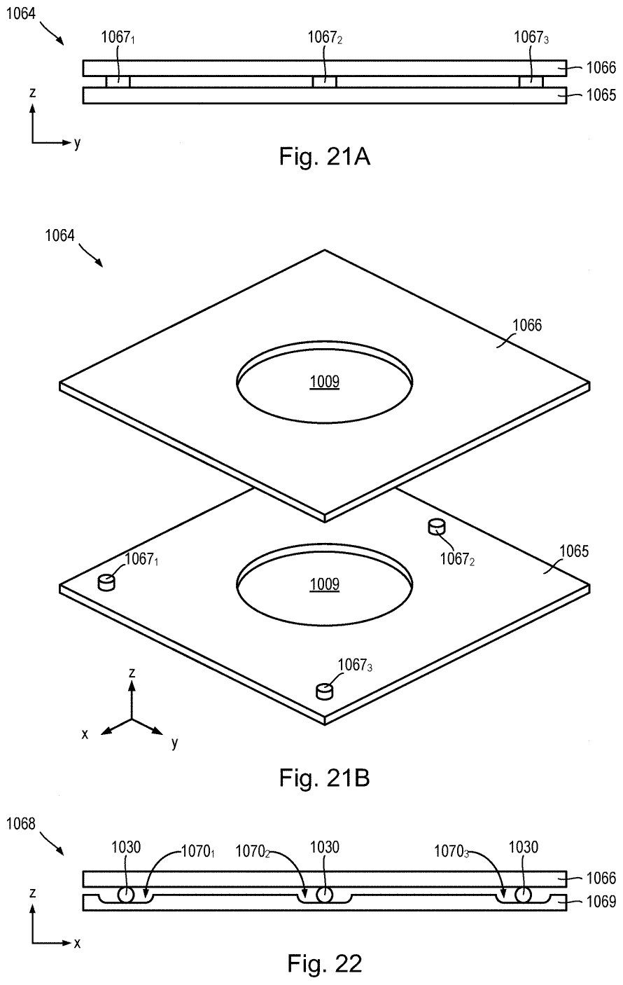

Referring also to FIGS. 21A and 21B, a first planar bearing 1064 (also referred to as a three-point bearing) is shown.

FIG. 21A is a side view and FIG. 21B is an exploded projection view.

The first planar bearing 1064 includes a first plate 1065 which slides in contact with a second plate 1066. The first plate 1065 supports at least three cylindrical protrusions 1067 including at least first 1067₁, second 1067₂ and third 1067₃ cylindrical protrusions which are not co-linear, for example arranged at the points of a triangle. The second plate 1066 is urged into contact with the flat surfaces of the cylindrical protrusions 1067 by biasing means (not shown in FIGS. 21A and 21B), and is free to slide in a plane parallel to the first and second axes x, y, and to rotate about an axis parallel to the primary axis z. In this way, the relative motions between the first plate 1065 and the second plate 1066 correspond to Tx, Ty and/or Rz. Unless a biasing force urging the plates 1065, 1066 together is overcome, the movements Tz, Rx and Ry are constrained.

In the example shown in FIGS. 21A and 21B, both plates 1065, 1066 take the form of an annulus having a rectangular outer perimeter and a circular inner perimeter defining a central aperture 1009. However, the shape of the plates 1065, 1066 is not relevant to the function of the first planar bearing 1064, and any shapes of plate may be used instead. Although three cylindrical protrusions 1067₁, 1067₂, 1067₃ are shown in FIGS. 21A and 21B, in general any number of cylindrical protrusions greater than or equal to three may be used. The flat actuator assembly 15 (FIG. 4) includes an implementation of a first planar bearing 1064.

Referring also to FIG. 22, a second planar bearing 1068 is shown.

The second planar bearing 1068 is the same as the first planar bearing 1064, except that the cylindrical protrusions 67 are replaced by ball bearings 1030₁, 1030₂, 1030₃. The first plate 1065 may also be replaced with a third plate 1069 including recesses 1070₁, 1070₂, 1070₃, for example circular indents, for receiving corresponding ball bearings 1030₁, 1030₂, 1030₃. The second planar bearing 1068 functions in the same way as the first planar bearing 1064, except that the second planar bearing 1068 is a rolling bearing instead of a plain bearing.

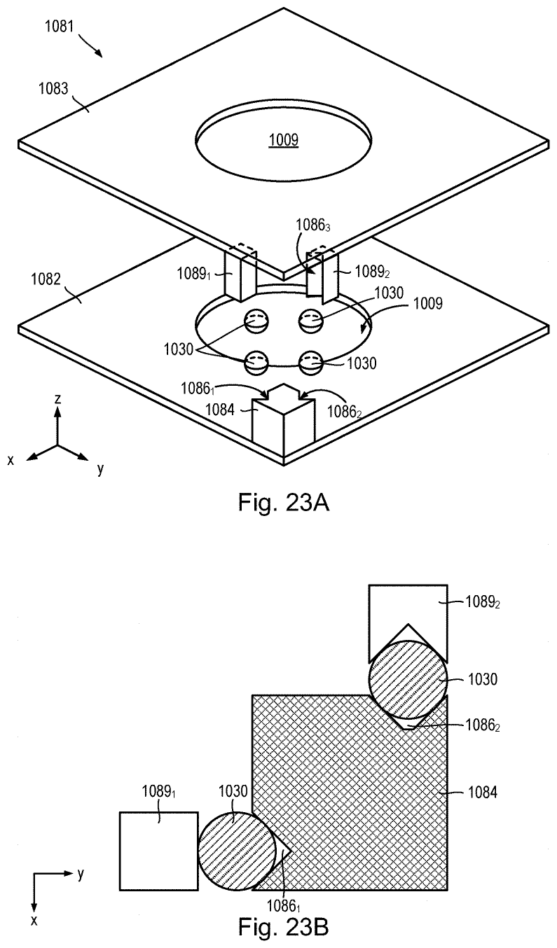

Referring also to FIGS. 23A and 23B, a z-translation bearing 1081 is shown.

FIG. 23A shows an exploded projection view and FIG. 23B shows a section through a block 1084 of the assembled z-translation bearing 1081.

The z-translation bearing 1081 includes a first plate 1082 and a second plate 1083. Both plates 1082, 1083 take the form of an annulus having a rectangular outer perimeter and a circular inner perimeter defining a central aperture 1009. A block 1084 extends perpendicular to a surface of the first plate 1082. As drawn in FIG. 23A, the first and second plates 1082, 1083 are parallel to the first and second axes x, y and the block 1084 extends in a direction parallel to the primary axis z. The block 1084 is generally cuboidal, with the exceptions of first and second faces of the block 1084 including V-shaped channels 1086₁, 1086₂ oriented substantially parallel with the primary axis z.

A pair of ball bearings 1030 is received into each V-shaped channel 1086₁, 1086₂, and the ball bearings 1030 are retained in the V-shaped channels 1086₁, 1086₂ by respective cuboidal protrusions 1089₁, 1089₂ which extend from the second plate 1083 which. At least one (in other examples both) of the cuboidal protrusions 1089₁, 1089₂ includes a V-shaped channel 10863 configured to oppose one of the V-shaped channels 1086₁, 1086₂ of the block 1084. Biasing means (not shown) for loading the bearings and ball-retaining means (not shown) are also generally included.

In this way, permitted relative motions between the first plate 1082 and the second plate 1083 correspond to Tz, whilst all other movements Tx, Ty, Rx, Ry, Rz are constrained.

Although a single block 1084 and corresponding protrusions 1089₁, 1089₂ are shown in FIGS. 23A and 23B, in some example two of more blocks 1084 may be used in conjunction with corresponding sets of corresponding protrusions 1089₁, 1089₂.

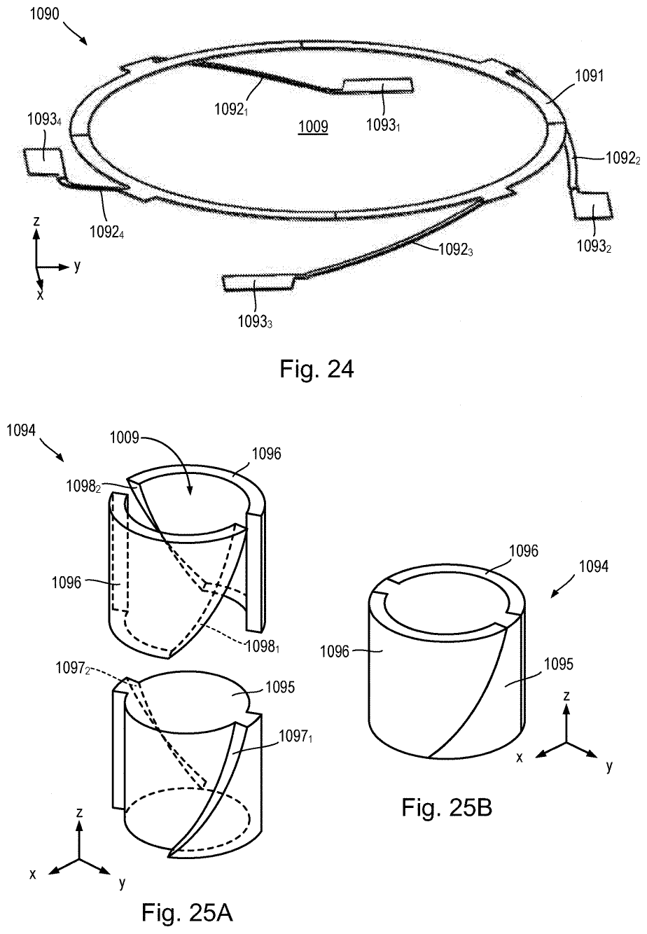

Referring also to FIG. 24, an example of a helical flexure bearing 1090 is shown.

The helical flexure bearing 1090 includes a circular annulus 1091 having a central aperture 1009 and connected to three or more (preferably four or five) helical beam portions 1092. In the example shown in FIG. 24, there are four helical beam portions 1092₁, 1092₂, 1092₃, 1092₄. At the end not connected to the circular annulus, each helical beam portion 1092₁, 1092₂, 1092₃, 1092₄ is connected to a pad 1093₁, 1093₂, 1093₃, 1093₄, for example for connection to a layer or structure below (in relation to the primary axis z as drawn) the circular annulus 1091.

Each helical beam portion 1092₁, 1092₂, 1092₃, 1092₄ is approximately tangential to the circular annulus 1091 (in the same sense) and its span includes both a first component parallel to the plane containing the first and second axes x, y and a second component parallel to the primary axis z. If the pads 1093₁, 1093₂, 1093₃, 1093₄ are clamped and a force is exerted upwards (positive z direction) on the circular annulus 1091, then in response the helical beam portions 1092₁, 1092₂, 1092₃, 1092₄ will deflect in the direction of that force. However, in doing so, the ends connected to the circular annulus are also deflected closer the respective pad 1093₁, 1093₂, 1093₃, 1093₄, causing the circular annulus 1091 to rotate clockwise about an axis parallel to the primary axis z. Conversely, a force exerted downwards (negative z direction) on the circular annulus 1091 will result in both a downwards movement of the circular annulus 1091 and also an anti-clockwise (counter-clockwise) rotation of the circular annulus 1091.

In this way, the helical flexure bearing 1090 acts to convert a relative displacement parallel to the primary axis z into a rotation about the primary axis z and to convert a rotation about the primary axis z into a relative displacement parallel to the primary axis z. However, the movements are not independent of one another, and relative to clamped pads 1093₁, 1093₂, 1093₃, 1093₄ the circular annulus 1091 is constrained to move along an approximately helical path. Since this does not reflect independent degrees-of-freedom, the motion will be denoted as [Tz, Rz] to highlight the relationship between translation Tz parallel to the primary axis z and rotation Rz about the primary axis z for this bearing type.

Although the helical beam portions 1092₁, 1092₂, 1092₃, 1092₄ shown in FIG. 24 are curving, in other examples of helical flexure bearings 1090 the helical beam portions 1091 may be straight. Further examples of helical flexure bearings 1090 are described in WO 2019/243849 A1, the contents of which are incorporated herein by reference in their entirety. FIGS. 19 to 22 of WO 2019/243849 A1 and the accompanying description on page 22, line 23 to page 23, line 24 are particularly relevant to helical flexure bearings 1090. Additional examples of implementing helical flexure bearings 1090 are also shown and described hereinafter.

Referring also to FIGS. 25A and 25B, an example of a helical bearing 1094 is shown.

FIG. 25A is an exploded projection view and FIG. 25B is a projection of the assembled helical bearing 1094. Occluded features are shown using dashed lines in FIG. 25A.

The helical bearing 1094 includes a first structure 1095 and a second structure 1096 configured to fit together for sliding motion between helical surfaces 10971, 10972 of the first structure 1095 and helical surfaces 10981, 10982 of the second structure 1096. Biasing means (not shown) urge the first and second structures 1095, 1096 together to maintain the pairs of helical surfaces 10971 and 10981, 10972, 10982 in contact. In this way, the relative motions between the first and second structures 1095, 1096 are constrained to a helical path [Tz, Rz].

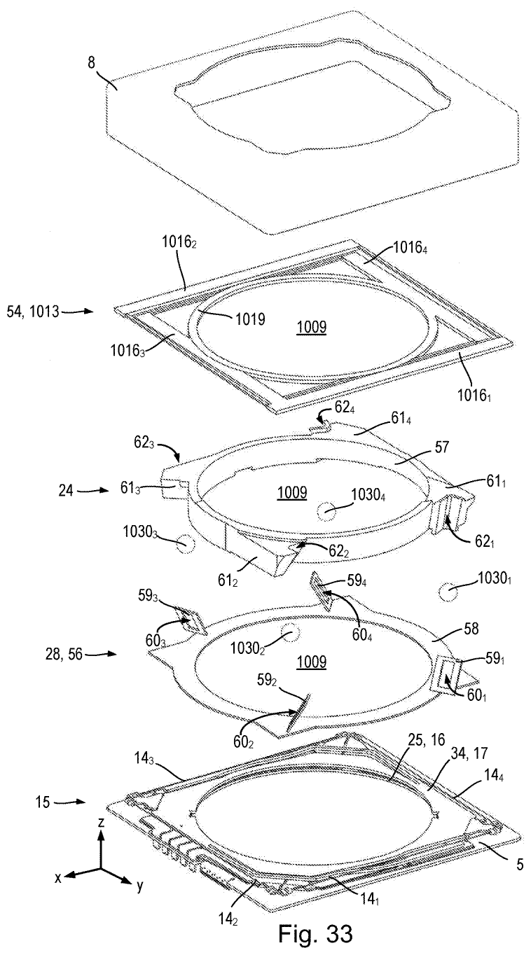

The example shown in FIGS. 25A and 25B prioritises visual clarity of the functioning of a helical bearing over practicality of implementation, and specific embodiments described hereinafter include additional examples more suited to incorporation into a device such as a camera 1. In particular, although the helical surfaces 1097, 1098 may be curved to follow a helical path as shown in FIGS. 25A and 25B, in other examples the helical surfaces 1097, 1098 may be substantially planar, for example ramps. Although the helical bearing 1094 shown in FIGS. 25A and 25B is a plain bearing, other helical bearings in the form of rolling bearings are also possible (FIG. 33). Further examples of helical bearings 1094 may be found in WO 2019/243849 A1 (already incorporated by reference). In particular, see FIGS. 1 to 18 of WO 2019/243849 A1 and the corresponding description on page 7, line 10 to page 22, line 21.

Although illustrated and described in particular orientations with respect to a set of right-handed Cartesian axes x, y, z for reference, any of the bearings described hereinbefore may be oriented at an arbitrary angle.

The bearings described hereinbefore may be formed of any suitable materials and using any suitable fabrication methods. For example, plate- or sheet-like components may be fabricated from metal sheets, for example stainless steel, with patterning provided by chemical or laser etching. Milling or stamping could be used provided that this does not unacceptably introduce residual strains causing distortion of parts. After patterning, such parts may be bent or pre-deformed as needed. Complex three-dimensional parts may be built up by attaching parts to plates, sheets or other parts, for example using adhesives, welding, brazing, soldering and so forth. Alternatively, complex three-dimensional parts may be formed by, for example, sintering or die-casting of metals, or by injection moulding of polymers. Any bearing surfaces may be made from, or may include an upper layer or coating of, a polymer such as Polyoxymethylene (POM, Acetal), Polytetrafluoroethylene (PTFE), or PTFE impregnated POM. Any bearing surfaces may be made from, or may include an upper layer or coating of Stainless steel or phosphor bronze with coatings of Titanium Carbide, Tungsten Carbon Carbide, Diamond Like Coating (DLC), Chromium Carbide DLC. These bearing materials may interface with a second bearing surface formed of one of these bearing materials, which could be polished or stamped to reduce the effects of friction generated by surface texture.

First Combined AF and OIS Actuator Assembly

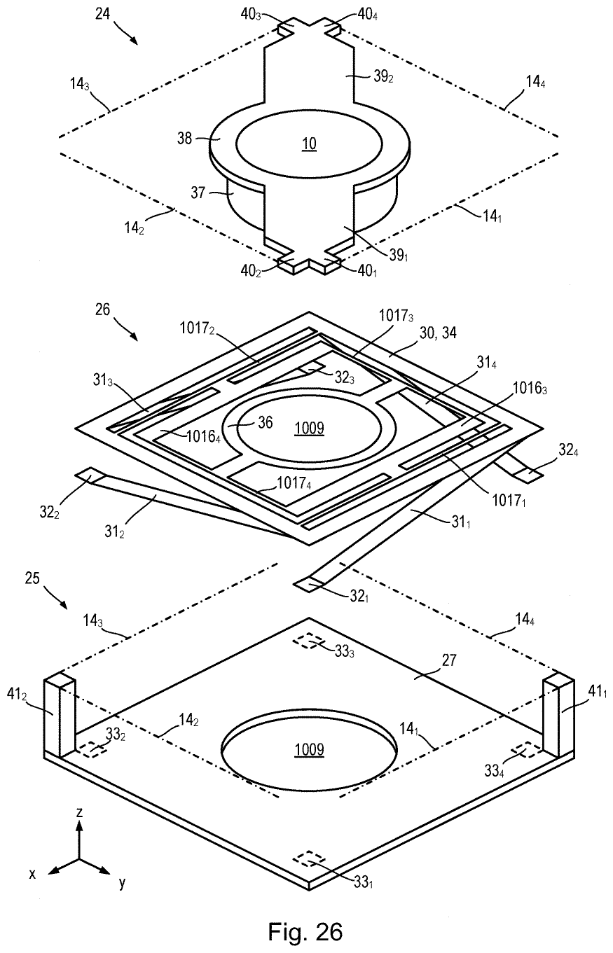

Referring also to FIGS. 26 to 28, a first AF and OIS actuator assembly 23 (hereinafter first actuator assembly) is shown.

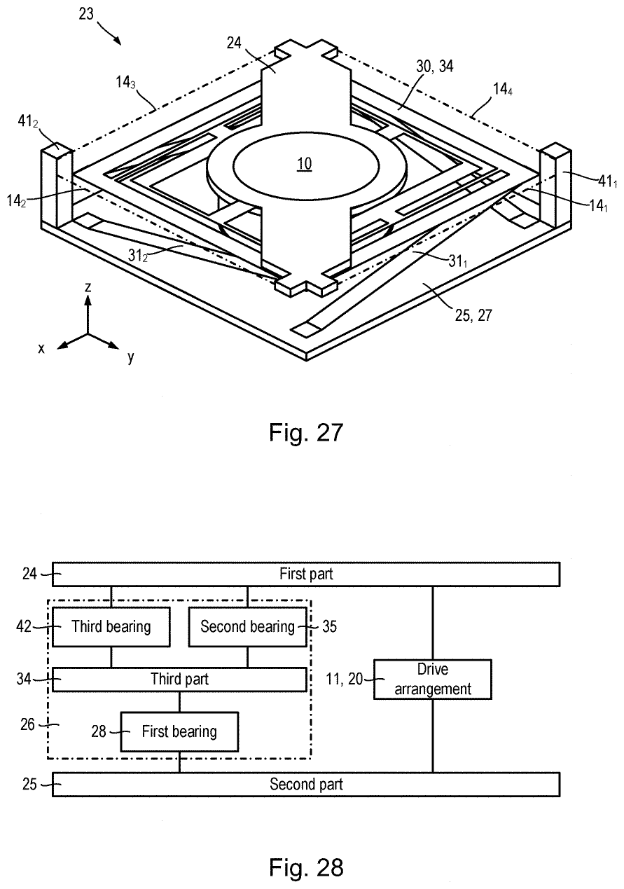

FIG. 26 shows an exploded perspective view of the first actuator assembly 23, FIG. 27 shows a perspective view, and FIG. 28 presents a schematic of the connections between the elements of a bearing arrangement and a drive arrangement of the first actuator assembly 23.

The first actuator assembly 23 takes the form of a four-SMA-wire actuator assembly. The first actuator assembly 23 may be used to enable three-dimensional translational movement Tx, Ty and/or Tz of a lens assembly 3, without trying to constrain rotation Rz of the lens assembly 3 about the optical axis O (parallel to the primary axis z).

The first actuator assembly 23 includes a first part 24, a second part 25 and a bearing arrangement 26 mechanically coupling the first part 24 to the second part 25. The first actuator assembly 23 also includes an implementation of the first drive arrangement 11.

The second part 25 includes a base plate 27 in the form of an annulus having a rectangular outer perimeter and a circular inner perimeter. The functions of the first actuator assembly 23 shall be described with reference to a set of axes fixed to the second part 25. A primary axis z extends perpendicular to the base plate 27. First x and second axes y are perpendicular to the primary axis z, and the second axis y is different to first axis x. In FIGS. 26 and 27 the first and second axes x, y are perpendicular to one another.

The first drive arrangement 11 and the bearing arrangement 26 are configured such that the first part 24 is movable Tz towards or away from the second part 25 along the primary axis z, and such that the first part 24 is movable Tx, Ty relative to the second part 25 along the first axis x and/or the second axis y.

The bearing arrangement includes a first bearing 28 configured to generate, in response to a torque applied about the primary axis z by the drive arrangement 11, movement of the first part 24 towards or away from the second part 25 along the primary axis z. The first bearing 28 provides this function by guiding helical movement [Tz, Rz] about and along the primary axis z, by coupling a rotation Rz about the primary axis z to a translation Tz along the primary axis z.

A rotation Rz of the first bearing 28 about the primary axis z will correspond to a rotation Rz of the first part 24 relative to the second part 25 about the primary axis z.

In the example shown in FIGS. 26 and 27, the first bearing 28 takes the form of a helical flexure formed from a rectangular annulus 30 from which four straight helical beam portions 31₁, 31₂, 31₃, 31₄ extend to respective pads 32₁, 32₂, 32₃, 32₄ at the free ends. The helical flexure is the same as the helical flexure 1090, except that a rectangular annulus 30 is used instead of circular annulus 1091, and straight helical beam portions 31 are used instead of curved helical beam portions 1092. The pads 32₁, 32₂, 32₃, 32₄ are fixed to the base plate 27 at corresponding attachment locations 33₁, 33₂, 33₃, 33₄, for example by welding, adhesive, or other suitable attachment methods. In this way, the first bearing 28 mechanically couples the second part 25 to a third part 34 in the form of the rectangular annulus 30.

The bearing arrangement 26 also includes a second bearing 35 mechanically coupling the first part 24 to the third part 34 and configured to guide movements Tx and/or Ty of the first part 24 relative to the third part 34 along the first axis x and/or the second axis y. The second bearing 35 should also constrain rotation Rz of the first part 24 relative to the third part 34 about the primary axis z.

In the example shown in FIGS. 26 and 27, the second bearing 35 takes the form of the third non-rotating general bearing 1023, with the free ends 1024₁, 1024₂, 1024₃, 1024₄ fixed to (or integrally formed with) the interior perimeter of the rectangular annulus 30, and with the central annular portion 1019 replaced with a circular annulus 36 surrounding a central aperture 1009.

The first part 24 takes the form of a lens carriage having a cylindrical portion 37 topped at an upper end (with respect to the primary axis z) with a lip 38 in the form of a circular annulus having an outer diameter greater than the cylindrical portion 37. One or more lenses 10 are received within the inner diameter of the cylindrical portion 37. First and second arms 39₁, 39₂ extend in generally radial directions from opposite sides of the cylindrical portion 37. Upper and lower surfaces (with respect to the primary axis z) of the arms 39₁, 39₂ are flush with upper and lower surfaces of the lip 38. The first arm 39₁ terminates in first and second SMA wire attachment points 40₁, 40₂, and the second arm 39₂ terminates in third and fourth SMA wire attachment points 40₃, 40₄.

When the first actuator assembly 23 is assembled, the cylindrical portion 37 is received through the central aperture 1009 of the circular annulus 36 and the underside of the lip 38 is fixed to the circular annulus 36, for example by welding, adhesive, or other suitable attachment methods. When assembled, the lip 38 and arms 39₁, 39₂ are at substantially the same height along the primary axis z as first and second protrusions 41₁, 41₂ which extend upwards (in a direction along the primary axis z) from the base plate 27. The first and second protrusions 41₁, 41₂ are positioned at diagonally opposed corners of the base plate 27. An implementation of the first drive arrangement 11 is provided by connecting the first SMA wire 14₁ between the first protrusion 41₁ and the first SMA wire attachment point 40₁, connecting the second SMA wire between the second protrusion 41₂ and the second SMA wire attachment point 40₂, connecting the third SMA wire 14₁ between the second protrusion 41₂ and the third SMA wire attachment point 40₃, and connecting the fourth SMA wire between the first protrusion 41₁ and the fourth SMA wire attachment point 40₄.

When the first drive arrangement 11 applies forces corresponding to a lateral shift (forces perpendicular to the primary axis z) to the first part 24, i.e. a movement having components Tx and/or Ty along corresponding first and second axes x, y, this movement is constrained by the first bearing 28 in the form of the helical flexure, but is guided by the second bearing 35 in the form of the third non-rotating general bearing 1023. Consequently, the response to application of forces corresponding to a lateral shift by the drive arrangement 11 will be primarily a lateral shift of the first part 24 relative to the second part 25, accommodated and guided by the second bearing 35. However, if the first drive arrangement 11 additionally or alternatively applies a torque about the primary axis z, the second bearing 35 is substantially constrained from rotation about the primary axis z. Consequently, the second bearing 35 will transmit substantially all of an applied torque to the first bearing 28. In response to the applied torque, the first bearing 28 will undergo a helical motion [Tz, Rz] along and about the primary axis z.

In this way, the first actuator assembly 23 may provide an OIS function based on lateral shifts Tx and/or Ty, and an AF function based on helical movement [Tz, Rz], using a drive arrangement 11 including a total of 4 SMA wires 14₁, 14₂, 14₃, 14₄. The two functions may be substantially independent, because the first drive arrangement 11 is capable of applying torques and lateral forces substantially independently across at least part of a range of motion.

The first actuator assembly 23 also includes a third bearing 42 in the form of a planar bearing formed by sliding of the first part 24 against parts of the second bearing 28 not fixed to the first part 24. In the example shown in FIGS. 26 and 27, the arms 39₁, 39₂ simply slide in contact with rigid portions 1016 and beam portions 1017 to provide a planar (and plain) bearing.

Although explained with reference to the specific example shown in FIGS. 26 and 27, the first actuator assembly 23 may be varied through a large number of permutations to provide the same functionality.

Referring in particular to FIG. 28, although the first actuator assembly 23 has been explained with the second part 25 corresponding to a support structure 4 of a camera and the first part 24 corresponding to a lens carriage 9 of a lens assembly 3, the roles may be reversed so that the second part 25 corresponds to a lens carriage 9 and the first part 24 provides a support structure 4. Equally, the first actuator assembly 23 need not be restricted to use in a camera 1, and the first and second parts 24, 25 may be any parts requiring the relative motions Tx, Ty and/or [Tz, Rz].

Although shown in FIGS. 26 and 27 using a particular type of helical flexure, the first bearing 28 may be any type of bearing or flexure which responds to an applied torque with helical motion [Tz, Rz]. For example, the first bearing may take the form of a helical bearing 1094, one or more helical tracks (not shown) similar to a screw thread, a number of ramps arranged in a loop (FIG. 33), and so forth. Similarly, the first bearing 28 may be a different type of helical flexure, for example the helical flexure bearing 1090, or any helical flexure including a flat ring and at least three flexures in the form of helical beam portions, e.g. 31, 1092, extending from the flat ring. There may be four or five or more flexures 1092 extending from the flat ring, and the flexures 1092 may be attached at equally-spaced angles around the flat ring. Preferably, the flat ring and flexures 1092 of a helical flexure are formed as a single-piece (single component).

Although shown in FIGS. 26 and 27 using the third non-rotating general bearing 1023, the second bearing 35 may be any bearing which guides motions Tx, Ty along first and/or second axes x, y whilst constraining rotation Rz about the primary axis z. For example, the second bearing 35 could be, without limitation, any one of the first to third non-rotating general bearings 1013, 1021, 1023, the first or second x-y bearings 1026, 1033 using nested or stacked ball bearing races to guide the movements Tx, Ty, the third x-y bearing 1037 using protrusions 1040 and elongated through holes 1042 to guide movements Tx, Ty, and the fourth x-y bearing 1043 using tabs 1046 to guide movements Tx, Ty of sliding portions 1045.

Although shown in FIGS. 26 and 27 as a rectangular annulus 30, the third part 34 may in general be any structure suitable for mechanically coupling the first and second bearings 28, 35.

Although shown in FIGS. 26 and 27 as a simple sliding contact between the first part 24 and parts of the second bearing 35 not fixed to the first part 24, alternative types of third bearing 42 may be used to couple the second and third parts 25, 34 in parallel with the second bearing 35. For example and without limitation, the first or second planar bearings 1064, 1068 may be used. When the type of second bearing 35 used does not constrain rotations Rx, Ry of the first part 24 relative to the third part 34 about the first and/or second axes x, y, the third bearing 42 may provide constraint against these rotations Rx, Ry. For example, the first to third non-rotating general bearings 1013, 1021, 1023 would need additional constraint of the rotations Rx, Ry, whilst such constraints are built in to the first to fourth x-y bearings 1026, 1033, 1037, 1043, in which case there may be no need for a separate third bearing 42.

Although the example shown in FIGS. 26 and 27 uses an implementation of the first (flat) drive arrangement 11, the second (angled) drive arrangement 20 may be used instead. The angled drive arrangement 20 may apply a force along the primary axis z in combination with a torque about the primary axis z, which may help with smoother helical movement [Tz, Rz] of the first bearing 28.

Providing the OIS and AF functions using a single drive arrangement 11, 20 including a total of four SMA wires 14₁, 14₂, 14₃, 14₄, and requiring no fifth or further SMA wires may advantageously reduce the complexity and/or power consumption of a SMA actuator 2 for a camera 1. Moreover, a second drive arrangement, whether based on SMA wires or other technologies, is neither included nor necessary. Combined AF and OIS may reduce costs of parts, assembly and/or testing. The robustness of the bond/coupling between OIS and

AF functions may also be improved. Furthermore, moving electrical connections between a static part and a separate AF drive system moving with the OIS actuation are not required.

Each of the four shape memory alloy wires 14₁, 14₂, 14₃, 14₄, corresponds to a section of SMA wire over which a drive current may be controlled independently. For example, a pair of SMA wires (e.g. 14₁, 14₂) may be provided by a single physical wire having a first current source (not shown) connected to one end, a second current source (not shown) connected to the other end and a current return connection (not shown) at a point between the two ends.

As additional advantage of the combined AF and OIS is that the first actuator assembly 23 could potentially be controlled from the output of a single three-axis hall sensor. Such a sensor may be mounted on a static section of the first actuator assembly 23 (either the first or second part 24, 25 depending on the configuration) to avoid potential hysteresis in rotation restraining lens carriage rotation. For example, a magnet (not shown) could be mounted to the first part 24 and a three-axis hall sensor (not shown) could be mounted to the second part 25 in the example shown in FIGS. 26 and 27.

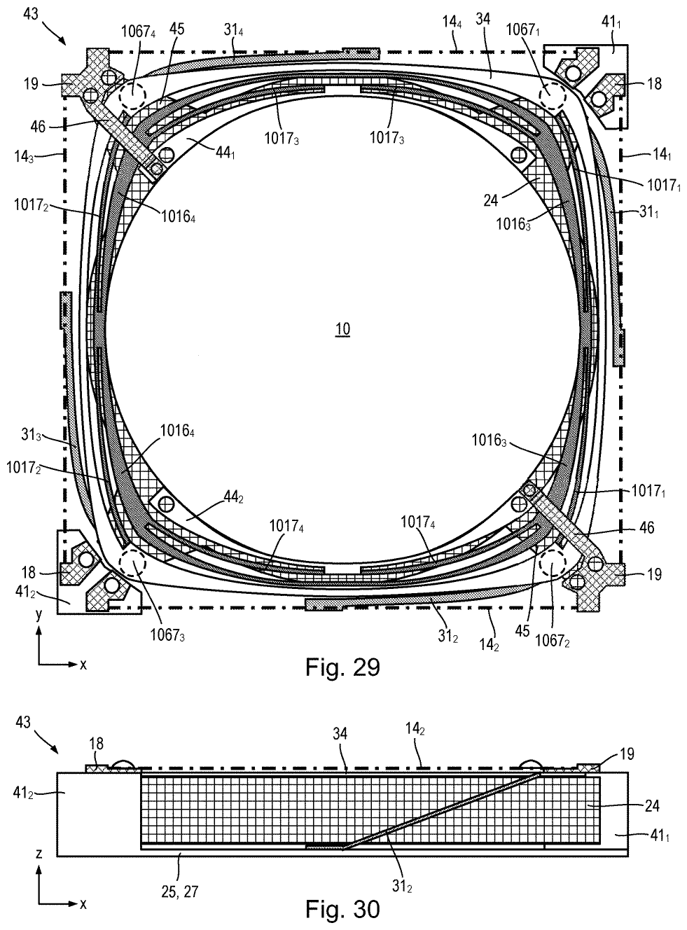

Second combined AF and OIS actuator assembly Referring also to FIGS. 29 and 30, a second AF and OIS actuator assembly 43 (hereinafter second actuator assembly) is shown.

FIG. 29 shows a top view of the second actuator assembly 43 and FIG. 30 shows a side view.

The second actuator assembly 43 takes the form of a four-SMA-wire actuator assembly. The second actuator assembly 43 is the same as the first actuator assembly 23 in that the first bearing 28 takes the form of a helical flexure and the second bearing 35 takes the form of a non-rotating general bearing including first to fourth beam portions 1017₁, 1017₂, 1017₃, 1017₄. However, the third bearing 42 of the second actuator assembly 23 is provided by an example of the first planar bearing 1064 including four cylindrical protrusions 1067 arranged in a rectangular configuration. The second actuator assembly 43 also differs from the first actuator assembly 23 in that the shapes and configurations of the elements of the first and second bearings 28, 35 are configured to reduce size both laterally (parallel to first and second axes x, y) and vertically (parallel to the primary axis z), when compared to the first actuator assembly 23.

Additionally, the first part 24 in the form of a lens carriage 9 is coupled to the second bearing via first and second connecting portions 44₁, 44₂. The third part 34 and the second bearing 35 are located above the first part 24 in the second actuator assembly 43. The moving crimps 19 are attached to the first part 24 at the distal ends of arms 45 extending outwards (generally radially) from the first part 24. The moving crimps 19 include extensions 46 which pass over the second bearing 35 and third part 34 before connecting again to the first part 24.

The extensions 46 may function to constrain any movement Tz along the primary axis z between the second and third parts 25, 34.

Third Combined AF and OIS Actuator Assembly

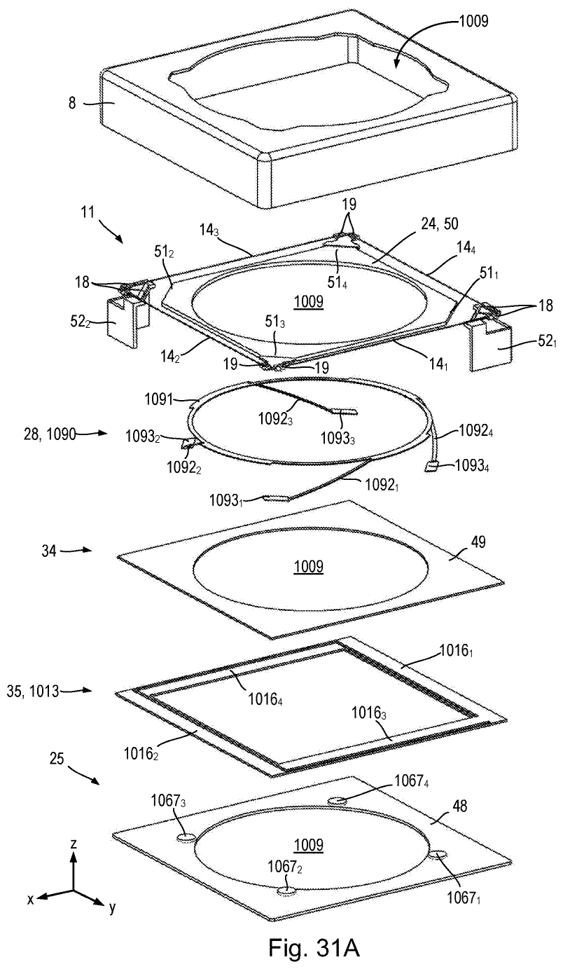

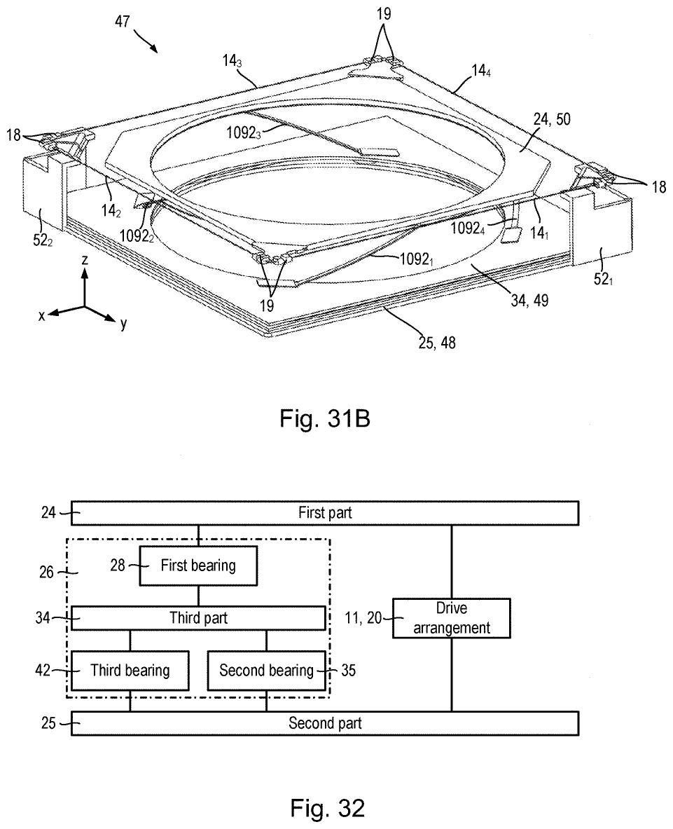

Referring also to FIGS. 31A, 31B and 32, a third AF and OIS actuator assembly 47 (hereinafter third actuator assembly) is shown.

FIG. 31A shows an exploded projection view of the third actuator assembly 47, FIG. 31B shows a projection view and FIG. 32 shows a schematic.

The third actuator assembly 47 takes the form of a four-SMA-wire actuator assembly. The third actuator assembly 47 differs from the first actuator assembly 23 in the ordering of the first and second bearings 28, 35. Comparing FIGS. 28 and 32, in the first actuator assembly 23 the first bearing 28 couples the second part 25 to the third part 34, whereas in the third actuator assembly 47 the first bearing 28 couples the third part 34 to the first part 24.

The third actuator assembly 47 includes a second part 25 which in this example provides a support structure 4, in the form of a first annular plate 48 having a rectangular outer perimeter and a circular inner perimeter defining a central aperture 1009. The first annular plate 48 supports four cylindrical protrusions 1067 forming half of a planar third bearing 42. The other half of the planar third bearing 42 is provided by a third part 34 in the form of a second annular plate 49. The second annular plate 49 is generally co-extensive with the first annular plate 48, and has a rectangular outer perimeter and a circular inner perimeter defining a central aperture 1009.

The second bearing 35 takes the form of a first non-rotating general bearing 1013, except that the central annular portion 1019 and connecting portion 1020 are omitted. The second rigid portion 1016₂ of the second bearing 35, 1013 is fixed to the first annular plate 48, for example by welding, adhesive, or other suitable attachment methods. The fourth rigid portion 1016₄ is fixed to the second annular plate 49 in a similar way. In this way, the third part 34 in the form of the second annular plate 49 is able to move in Tx and/or Ty along first and/or second axes x, y relative to the second part 25 in the form of the first plate 48. Additionally, tension in the beam portions 1017₁, 1017₂, 1017₃, 1017₄ of the second bearing 35, 1013 maintains the second annular plate 49 in contact with the cylindrical protrusions 1067 to provide the third bearing 42 and constrain movement Tz along the primary axis z and rotations Rx, Ry about the first and/or second axis x, y.

The third actuator assembly 47 includes a first part 24 which in this example provides or supports a lens carriage 9 for a lens assembly 3. The first part 24 takes the form of a third annular plate 50 having an outer perimeter shaped as a rectangle with first and second diagonally opposite corners 51₁, 51₂ being truncated, and a circular inner perimeter defining a central aperture 1009. Third and fourth 51₃, 51₄ diagonally opposed corners of the third annular plate 50 support the moving crimps 19 of an implementation of the first drive arrangement 11. The corresponding static crimps 18 are supported by first and second pillars 52₁, 52₂ which are attached (using welding, adhesive or other suitable attachment methods) to diagonally opposed corners of the first annular plate 48 so as to be substantially aligned with the truncated corners 51₁, 51₂ of the third annular plate 50. The implementation of the first drive arrangement 11 is completed by connecting the four SMA wires 14₁, 14₂, 14₃, 14₄ between the respective static and moving crimps 18, 19.

The first part 24 in the form of the third annular plate 50 is coupled to the third part 34 in the form of the second annular plate 49 by a first bearing 28 in the form of the helical flexure 1090 as described hereinbefore. The pads 1093 are fixed to the second annular plate 49, for example by welding, adhesive or other suitable attachment methods, whilst the circular annulus 1091 is fixed to the third annular plate 50 in the same or a similar way.

Once assembled with a base 5 supporting an image sensor 6 and a lens assembly 3, a can 8 (also referred to as a “screening can”) is fitted over the third actuator assembly 47 to protect and contain the parts. The can 8 is omitted in FIG. 32 for visual purposes.

The third actuator assembly 47 is only one example of how the roles of the first and second parts 24, 25 may be reversed compared to the first or second actuator assemblies 23, 43—for example if the first and second parts 24, 25 in FIG. 32 are swapped, then FIG. 32 would be identical to FIG. 28 except upside-down. The first, second and third bearings 28, 35, 42 may be replaced with alternatives as described hereinbefore. Additionally or alternatively, the first drive arrangement 11 may be exchanged for an implementation of the second drive arrangement 20 by appropriate modification of the first and second pillars 52₁, 52₂.

Fourth Combined AF and OIS Actuator Assembly

The first, second and third actuator assemblies 23, 43, 47 permit relative rotation Rz between the first and second parts 24, 25 corresponding to the helical motion [Tz, Rz] of the first bearing 28. Whilst in principle a lens 10 for a camera should be circularly symmetric, in practice small imperfections in miniature lenses may break circular symmetry. Consequently, rotation of the first part 24 relative to the second part 25 may introduce aberrations into an image formed on an image sensor 6 (regardless of whether motion of a lens 10 is tied to the first or second part 24, 25).

It can be desirable to constrain rotation Rz of the first part 24 relative to the second part 25 about the primary axis z.

Referring also to FIGS. 33 to 35, a fourth AF and OIS actuator assembly 53 (hereinafter fourth actuator assembly) which constrains such rotation Rz is shown.

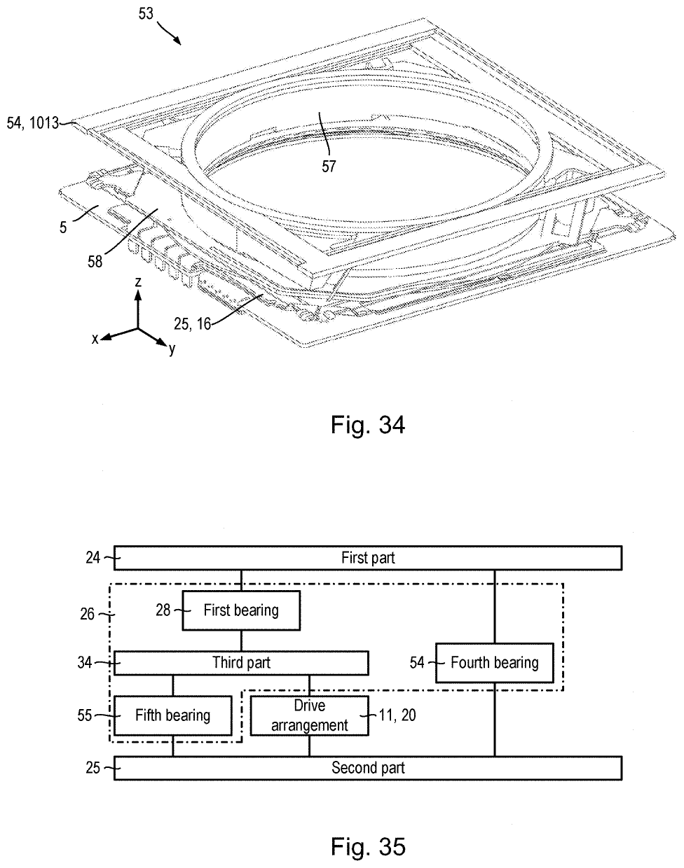

FIG. 33 shows an exploded projection view of the fourth actuator assembly 53, FIG. 34 shows a projection view, and FIG. 35 is a schematic diagram.

The fourth actuator assembly 53 takes the form of a four-SMA-wire actuator assembly. Referring in particular to FIG. 35, similarly to the first to third actuator assemblies 23, 43, 47, the fourth actuator assembly 53 includes a first part 24, a second part 25, and a third part 34 mechanically coupled to the first part 24 by a first (e.g. helical type) bearing 28 which is the same as for the first to third actuator assemblies 23, 43, 47. However, unlike the first to third actuator assemblies 23, 43, 47, a drive arrangement 11, 20 of the fourth actuator assembly 53 is connected between the second part 25 and the third part 34.

The bearing arrangement 26 of the fourth actuator assembly 53 is configured to constrain rotation Rz of the first part 24 relative to the second part 25 about the primary axis z. This function is provided by a fourth bearing 54 mechanically coupling the first part 24 to the second part 25 and configured to guide movement Tx, Ty, Tz of the first part 24 relative to the second part 24 along the first axis x, the second axis y and/or the third axis z, whilst constraining rotation Rz of the first part 24 relative to the second part 25 about the primary axis z. For example, the fourth bearing 54 could be, without limitation, any one of the first to third non-rotating general bearings 1013, 1021, 1023. Other bearings could be used but would need to be connected in series with a further bearing permitting translation Tz along the primary axis z. For example, a z-translation bearing 1081 could be connected in series with one of the first to fourth x-y bearings 1026, 1033, 1037, 1043.

The bearing arrangement 26 of the fourth actuator assembly 53 also includes a fifth (e.g. planar) bearing 55 mechanically coupling the second part 25 to the third part 34 connected in parallel with the drive arrangement 11, 20. The fifth bearing may take the same form as the third bearing 42 and/or may include any features and/or functions described hereinbefore in relation to the third bearing 42.

Referring in particular to FIGS. 33 and 34, the fourth actuator assembly 53 includes the flat actuator assembly 15 (see FIG. 4 in particular), of which the annular plate 16 provides the second part 25 and the annular sheet 17 provides the third part 34. As described hereinbefore, the annular sheet 17 is coupled to the annular plate 16 using the four SMA wires 14₁, 14₂, 14₃, 14₄ and slides over a fifth bearing 55 in the form of a planar bearing provided by three or more cylindrical protrusions (not shown in FIG. 33—see e.g. 1067₁ in FIG. 31).

A first bearing 28 in the form of a helical roller bearing 56 mechanically couples the third part 34 in the form of the annular sheet 17 to a first part 24 in the form of a lens carriage 57 which performs the function of supporting a lens or lenses 10 of a lens assembly 3 in the same way as lens carriage 9. The helical roller bearing 56 includes an annulus 58 having a circular inner perimeter defining a central aperture 1009, and an outer perimeter which alternates between rectangular and circular outlines. The annulus 58 supports four ramps 59₁, 59₂, 59₃, 59₄ equi-spaced in a loop about the central aperture 1009. Each ramp 59₁, 59₂, 59₃, 59₄ takes the form of a rectangular frame having an elongated aperture 60₁. 60₂, 60₃, 60₄ extending along a length of the ramp 59₁, 59₂, 59₃, 59₄ The ramps 59₁, 59₂, 59₃, 59₄ all make substantially equal angles to the annulus 58 (which lies in a plane parallel to first and second axes x, y). When assembled, each elongated aperture 60₁. 60₂, 60₃, 60₄ receives a corresponding ball bearing 1030₁, 1030₂, 1030₃, 1030₄.

The lens carriage 57 is generally cylindrical about a central aperture 1009 for mounting of one or more lenses 10. The lens carriage 57 also includes four protrusions 61₁, 61₂, 61₃, 61₄ extending radially outwards from the generally cylindrical lens carriage 57. The first protrusion 61₁ defines a first bearing surface 62₁ in the form of a V-shaped channel. The first bearing surface 62₁ is oriented generally upwards (normals to the first bearing surface 62₁ have components generally in the positive +z direction along the primary axis z). The second and fourth protrusions 61₂, 61₄ each defines a corresponding bearing surface 62₂, 62₄ in the form of a V-shaped channel oriented generally downwards (normals to the second/fourth bearing surface 62₂, 62₄ have components generally in the negative −z direction along the primary axis z). The third protrusion 61₃ defines a third bearing surface 62₃ in the form of an angled planar surface oriented generally upwards (normals to the third bearing surface 62₃ have components generally in the positive +z direction along the primary axis z).

When assembled, each bearing surface 62₁, 62₂, 62₃, 62₄ is in rolling contact with the corresponding ramp 59₁, 59₂, 59₃, 59₄ via the respective ball bearing 1030₁, 1030₂, 1030₃, 1030₄. However, the first and third bearing surfaces 62₁, 62₃ will lie below (relative to the primary axis z) the corresponding ramps 59₁, 59₃, whereas the second and fourth bearing surfaces 62₂, 62₄ will lie above the corresponding ramps 59₂, 59₄. This arrangement may be observed in FIG. 34.

The annulus 58 is fixed to the annular sheet 17, for example by welding, adhesive, or other suitable attachment methods. An upper surface (relative to the primary axis z) of the lens carriage 57 is fixed to a central annular portion 1019 of the fourth bearing 54. The fourth bearing 54 takes the form of a first non-rotating general bearing 1013, except that the connecting portion 1020 is omitted and the central annular portion 1019 is directly fixed to, or integrated as part of, the fourth rigid portion 1016₄. The second rigid portion 1016₂ is then rigidly connected to the annular plate 16, for example via the can 8 and base 5, to complete the coupling between the second part 25 in the form of the annular plate 16 and the first part 24 in the form of the lens carriage 57.

In use, if the drive arrangement 11 applies a lateral force (substantially perpendicular to the primary axis z), then the first bearing 28 cannot respond with a movement Tx and/or Ty in the direction of the applied lateral force. However, the fourth bearing 54 may guide movement Tx and/or Ty in the direction of the applied lateral force, and the central annular portion 1019 moves relative to the second part 25 in the form of the annular plate 16 along the first and/or second axes x, y. The lens carriage 57 (first part 24), and the annular sheet 17 (third part 34) move with the central annular portion 1019.

However, when the drive arrangement 11 additionally or alternatively applies a torque about the primary axis z, the fourth bearing 54 constrains the lens carriage 57 (first part 24) from rotating Rz relative to the annular plate 16 (second part 25). The response to an applied torque is that the third part 34 in the form of the annular sheet 17, and the attached annulus 58 and ramps 59₁, 59₂, 59₃, 59₄ will rotate. This rotation will cause the ball bearings 1030₁, 1030₂, 1030₃, 1030₄ to roll between the ramps 59₁, 59₂, 59₃, 59₄ and bearing surfaces 62₁, 62₂, 62₃, 62₄, displacing the lens carriage 57 (first part 24) up or down (relative to the primary axis z) depending on the direction of the torque and corresponding rotation Rz. However, the lens carriage 57 (first part 24) does not rotate Rz about the primary axis z because of the constraint provided by the fourth bearing 54. Besides facilitating up or down movement of the lens carriage 57 (first part 24), the under-over-under-over configuration of the ramps 59₁, 59₂, 59₃, 59₄ and bearing surfaces 62₁, 62₂, 62₃, 62₄ means that, when the fourth actuator assembly 53 is assembled the ramps 59₁, 59₂, 59₃, 59₄ are flexed, providing a loading force for the first bearing 28.

In this way, OIS and AF functions may be provided using a single drive arrangement 11, 20 including a total of four SMA wires 14₁, 14₂, 14₃, 14₄, whilst also avoiding rotation Rz of lenses 10 about the primary axis z. Amongst other things, this may improve the quality of images by reducing the possibility of aberrations resulting from imperfect circular symmetry of one or more lenses 10.

Although the fourth actuator assembly 23 has been explained with the second part 25 corresponding to a support structure 4 of a camera and the first part 24 corresponding to a lens carriage 9, 57 of a lens assembly 3, the roles may be reversed so that the second part 25 corresponds to a lens carriage 9, 57 and the first part 24 provides a support structure 4. Equally, the fourth actuator assembly 53 need not be restricted to use in a camera 1, and the first and second parts 24, 25 may be any parts requiring the relative motions Tx, Ty and/or Tz.

Although shown in FIGS. 33 and 34 using a particular type of helical roller bearing 56, the first bearing 28 may be any type of bearing or flexure which responds to an applied torque with helical motion [Tz, Rz], for example as described in relation to the first bearing 28 of the first actuator assembly 23.

Although shown in FIGS. 33 and 34 using the third non-rotating general bearing 1023, the fourth bearing 54 may be any bearing which guides motions Tx, Ty and/or Tz along first, second and/or primary axes x, y, z whilst constraining rotation Rz about the primary axis z. In other examples, the fourth bearing 54 could be replaced with one of the x-y bearings 1026, 1033, 1037, 1043 connected in series with a further bearing permitting translation Tz along the primary axis z, for example a z-flexure 1011 or a z-translation bearing 1081.

Although shown in FIGS. 33 and 34 as an annular sheet 17, the third part 34 may in general be any structure suitable for mechanically coupling the relevant elements (see FIG. 35).

As described hereinbefore, the fifth bearing 55 may take the same form as the third bearing 42 and/or may include any features and/or functions described hereinbefore in relation to the third bearing 42.

Although the example shown in FIGS. 33 and 34 uses an implementation of the first (flat) drive arrangement 11, an implementation of the second (angled) drive arrangement 20 may be used instead. The angled drive arrangement 20 may apply a force along the primary axis z in combination with a torque about the primary axis z, which may help with smoother helical movement [Tz, Rz] of the first bearing 28.

As explained hereinbefore, the fourth actuator assembly 53 may help to avoid any lens quality concerns associated with rotation of the lens 10. Additionally, parts such as the fourth bearing 54 and/or the annulus 58 and ramps 59 of the first bearing 28 may be formed from chemical or laser etching of single sheets of metal, for example stainless steel. The etchings may be bent following etching to angle the ramps 59. Alternatively, such parts may be formed by stamping of a metal sheet, combining removal of unwanted material with bending of parts into shape, although this approach is only possible when residual stresses in the formed parts will not result in undue distortion. Stamping combined with in-situ heating to permit creep relaxation could be considered. This may reduce complexity of manufacturing and/or assembly.

The use of the shaped lens carriage 57 may help to reduce a lateral (x-y) footprint of the fourth actuator assembly 53 compared to other types of helical bearing, though this may be at the expense of increased size of the fourth actuator assembly 53 along the primary axis z. This could help to address requirements for front facing cameras 1 that have limited lateral dimension so as to fit into a bezel space of a mobile phone handset.

The configuration of the fourth bearing 54 fixed to, and surrounded by the can 8, provides effective end stops between the lens carriage 57 and the can 8. This may reduce the possibility that that e.g. ball bearing 1030 surfaces, ramps 59 and/or bearing surfaces 62 may be damaged during impacts (for example dropping) to which a device incorporating the fourth actuator assembly 53 may be subjected. Because the SMA wires 14₁, 14₂, 14₃, 14₄ do not have to be in the same plane as the balls 1030 in the bearings, it may be easier to implement an end stop system to permit the relatively large mass of a lens 10 and lens carriage 57 to be directly transferred to the can 8. Consequently, the bearing surfaces 62 and ramps 59 may be loaded only with the relatively low mass of the rotating annulus 58 and attached annular sheet 17.

In the fourth actuator assembly 53, flexure of the beam portions 1017 of the fourth bearing 54 provide a restoring force urging the lens carriage 57 back to an equilibrium lateral position (along first and second axes x, y), whilst the flexing of the ramps 59 may provide a loading force for the bearings. Consequently, additional springs, magnets or other biasing means may not be required, simplifying the actuator design and assembly. This configuration may also help to prevent significant tilt (rotation) of the lens carriage 57 between powered and unpowered states of the SMA wires 14₁, 14₂, 14₃, 14₄. For example, the ramps 59 may be pre-stressed by a small amount of flexing in the equilibrium position.

Fifth AF and OIS Actuator Assembly

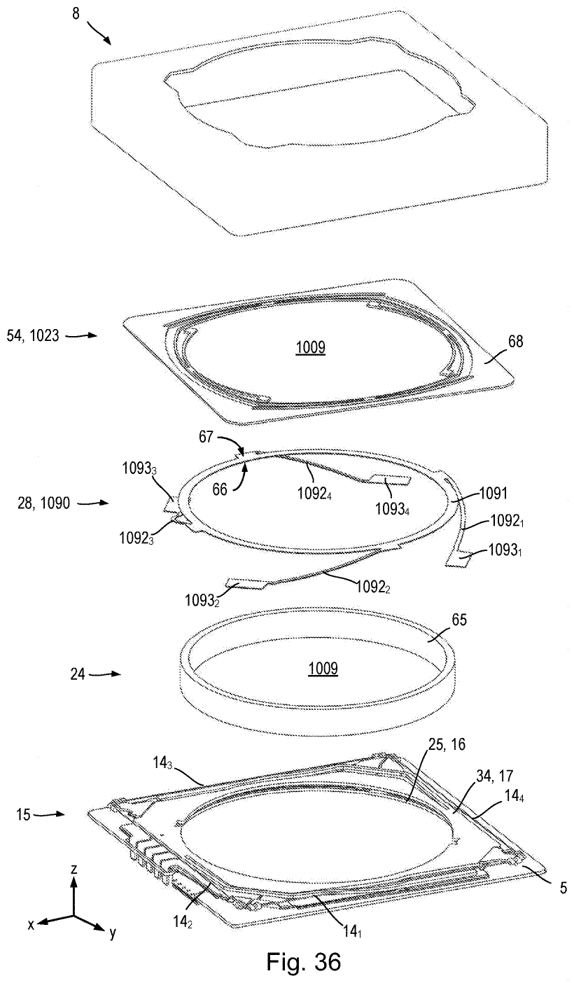

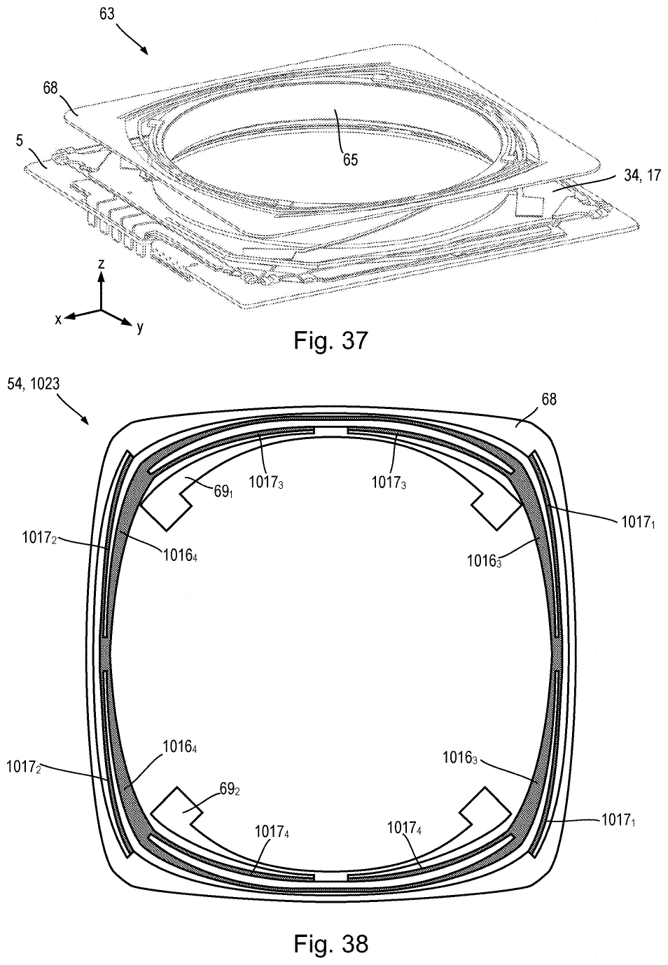

Referring also to FIGS. 36 and 37, a fifth AF and OIS actuator assembly 63 (hereinafter fifth actuator assembly) which constrains rotation Rz is shown.

FIG. 36 shows an exploded projection view of the fifth actuator assembly 63 and FIG. 37 shows a projection view.

The fifth actuator assembly 63 takes the form of a four-SMA-wire actuator assembly. The fifth actuator assembly 63 includes the flat actuator assembly 15 including the first drive arrangement 11, of which the annular plate 16 provides the second part 25 and the annular sheet 17 provides the third part 34 in the same way as the fourth actuator assembly 53.

The pads 1093₁₉, 1093₂, 1093₃, 1093₄ of a helical flexure 1090 providing the first bearing 28 are attached to the annular sheet 17 (third part 34), for example by welding, adhesives, or other suitable attachment methods. A first part 24 in the form of a hollow cylinder 65 having a central aperture 1009 is fixed to the circular annulus 1091 of the helical flexure 1090 (first bearing 28). The hollow cylinder 65 provides a lens carriage 9 for mounting one of more lenses 10. The hollow cylinder 65 is mounted to a lower surface 66 (relative to the primary axis z) of the circular annulus 1091 and depends below (relative to the primary axis z) the circular annulus 1091 of the helical flexure 1090. The length of the hollow cylinder 65 along the primary axis z leaves the bottom of the hollow cylinder 65 clear of the base 5 and of an image sensor 6 (not shown in FIG. 36) mounted on the base 5.

An upper surface 67 (relative to the primary axis z) of the circular annulus 1091 is fixed to one end of the fourth bearing 54, which in this case takes the form of an annular rigid frame 68 surrounding an implementation of the third non-rotating general bearing 1023. The annular rigid frame 68 has a generally rectangular outer perimeter and an inner perimeter defining a central aperture 1009. The third non-rotating general bearing 1023 is contained within the central aperture 1009 of the annular frame 68.

Referring also to FIG. 38, a plan view of an annular rigid frame 68 surrounding an implementation of the third non-rotating general bearing 1023 is shown.

The first and second beam portions 1017₁, 1017₂ respectively couple the annular frame 68 to third and fourth rigid portions 1016₃, 1016₄. Third and fourth beam portions 1017₃, 1017₄ couple the third and fourth rigid portions 1016₃, 1016₄ together. First and second mounting connectors 69₁, 69₂ are respectively coupled to midpoints of the third and fourth beam portions 1017₃, 1017₄. The first and second mounting connectors 69₁, 69₂ are fixed to the upper surface 67 of the circular annulus 1091.

The annular frame 68 is fixed relative to the second portion 25 in the form of annular plate 16, for example by fixing the annular frame 68 to the can 8 and the can 8 to the base 5. Other static linkages between the annular frame 68 and the second portion 25 may be used. Alternatively, one or more bearings permitting translation Tz along the primary axis z but constraining rotation Rz about the primary axis z may be coupled between the annular frame 68 and the second part 25, for example a z-flexure 1011 or a z-translation bearing 1081.

Sixth Combined AF and OIS Actuator Assembly

In the hereinbefore described actuator assemblies 23, 43, 47, 53, 63, separate bearings have been used to guide OIS movements Tx, Ty perpendicular to the primary axis z and AF movement Tz along the primary axis z. However, these motions need not be guided by entirely separate bearings.

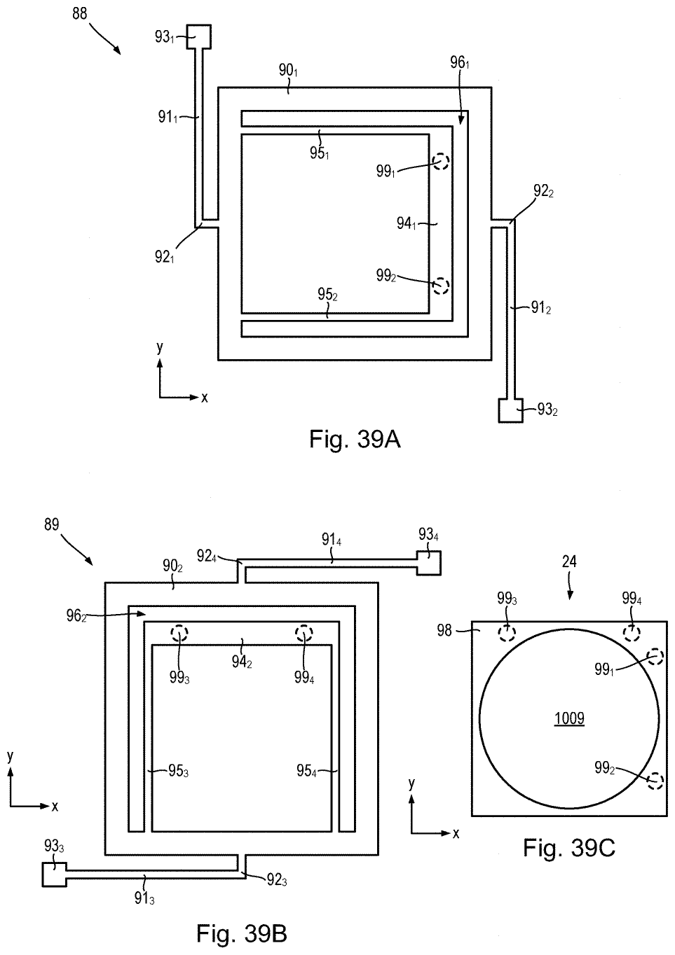

For example, referring also to FIGS. 39A to 42, a sixth combined AF and OIS actuator assembly 87 (hereinafter sixth actuator assembly) is shown.

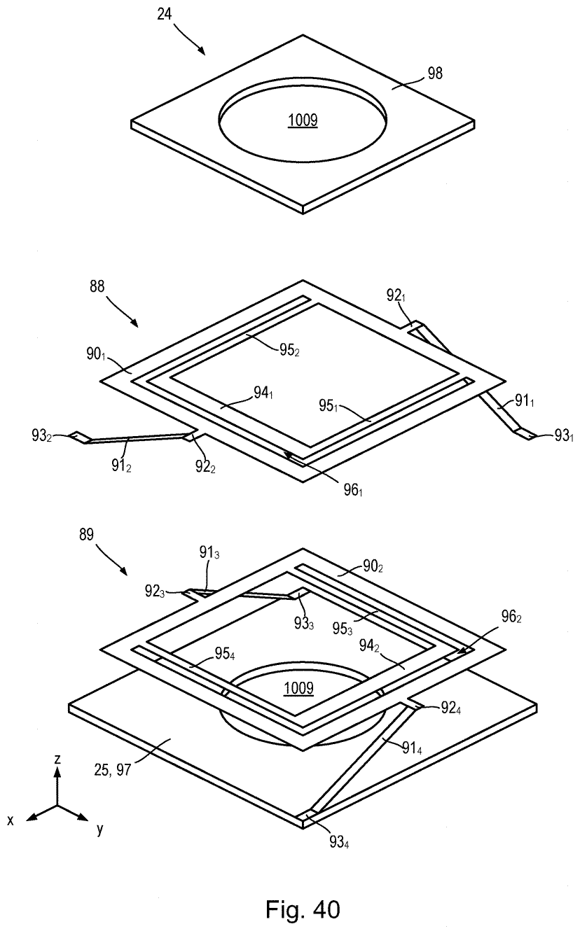

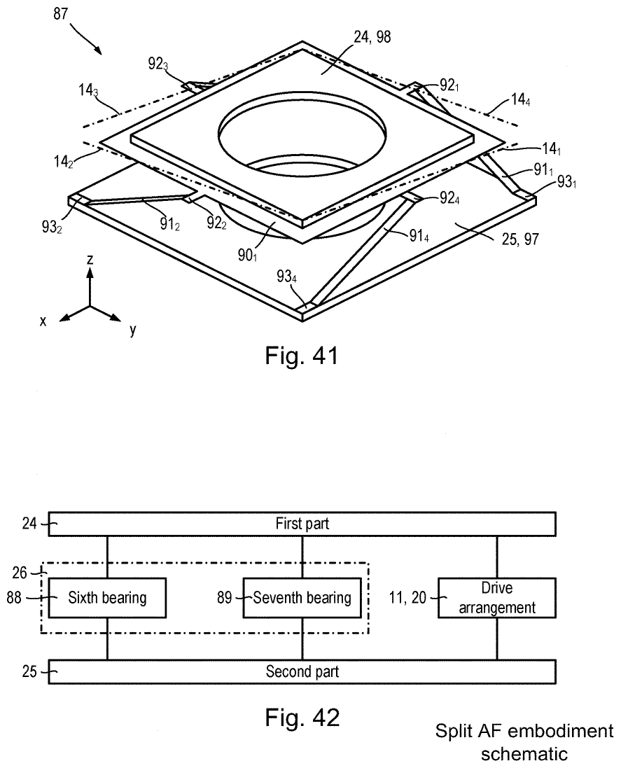

FIG. 39A is a plan view of a sixth bearing 88 formed from a single sheet prior to bending of helical beam portions, FIG. 39B is a plan view of a seventh bearing 89 formed from a single sheet prior to bending of helical beam portions, and FIG. 39C is a plan view of a first part 24 of the sixth actuator assembly 87. FIG. 40 is a partially exploded projection view of the sixth actuator assembly 87, FIG. 41 is a projection view, and FIG. 42 is a schematic.

The sixth actuator assembly 87 takes the form of a four-SMA-wire actuator assembly. The sixth actuator assembly 87 includes a first part 24 mechanically coupled to a second part 25 by the sixth and seventh bearings 88, 89 connected in parallel. The drive arrangement 11, 20 also connects between the first and second parts 24, 25.

The sixth bearing 88 includes a first rigid frame 90₁ in the form of a rectangular annulus. A first helical beam portion (helical flexure) 91₁ is connected by a first elbow joint 92₁ to a midpoint of an edge of the first rigid frame 90₁ extending in a direction parallel to the second axis y. The first helical beam portion 91₁ extends from the first elbow 92₁ in a direction having components along both second and primary axes y, z and terminates in a pad 93₁ at the free end. A second helical beam portion (helical flexure) 91₂ is connected by second elbow joint 92₂ to a midpoint of an edge of the first rigid frame 90₁ extending in a direction parallel to the second axis y. The second elbow joint 92₂ is opposite to the first elbow joint 92₁. The second helical beam portion 91₂ extends from the second elbow 92₂ in a direction having components along both second and primary axes y, z and terminates in a pad 93₂ at the free end. The second helical beam portion 91₂ extends in the same direction as the first helical beam portion 91₁ parallel to the primary axis z, and the opposite direction to the first helical beam portion 91₁ parallel to the second axis y.

A first rigid beam 94₁ is disposed within the first rigid frame 90₁ and extends in a direction parallel to the second axis y. The first rigid beam 94₁ is connected to the first rigid frame 90₁ by first and second beam portions (flexures) 95₁, 95₂ extending in a direction parallel to the first axis x and spaced apart in a direction parallel to the second axis y. In effect, the first rigid beam 94₁, the first and second beam portions 95₁, 95₂ and an edge of the first rigid frame 90₁ form a two-bar link 1001 enclosed within the first rigid frame 90₁. The first rigid beam 94₁ is closer to one edge of the first rigid frame 90₁ and separated from that edge by a gap 96₁.

The sixth bearing 88 can be formed by etching a sheet of metal, for example stainless steel to form a flat patterned sheet as shown in FIG. 39A. The helical beam portions 91₁, 91₂ are then bent from the elbows 92₁, 92₂ to form the shape shown in FIGS. 40 and 41. The first and second beam portions 95₁, 95₂ are also then bent (“pre-formed”) so that the first rigid beam 94₁ is lower (relative to the primary axis z) than the first rigid frame 90₁ and so urges the first rigid frame 90₁ upwards (relative to the primary axis z) once assembled as described below.

The seventh bearing 89 is identical to the sixth bearing 88, and is simply rotated 90 degrees about the primary axis z. For distinction in the discussion hereinafter, the seventh bearing 89 has been labelled as having a second rigid frame 90₂, third and fourth helical beam portions 91₃, 91₄, a second rigid beam 94₂ and third and fourth beam portions 95₃, 95₄.

The sixth and seventh bearings 88, 89 are not directly attached to one another. The first rigid beam 94₁ is fixed to a first part 24 in the form of a second annular plate 98 at first and second attachment sites 99₁, 99₂. The second annular plate 98 has a rectangular outer perimeter and a circular inner perimeter defining a central aperture 1009. The first and second attachment sites 99₁, 99₂ are positioned close to, but not at, the distal ends of the first rigid beam 94₁, spaced apart in a direction parallel to the second axis y. Similarly the second rigid beam 94₂ is fixed to the second annular plate 98 (first part 24) at third and fourth attachments sites 99₃, 99₄, positioned close to, but not at, the distal ends of the second rigid beam 94₂ and spaced apart in a direction parallel to the first axis x. In this way, the sixth and seventh bearings 88, 89 are connected in parallel between the annular plate 97 (second part 25) and the second annular plate 98 (first part 24).

To further assemble the sixth actuator assembly 87, the sixth and seventh bearings 88, 89 are attached to the second part 25 in the form of an annular plate 97 having a rectangular outer perimeter and a circular inner perimeter defining a circular aperture 1009. In particular, the first and second pads 93₁, 93₂ are fixed to diagonally opposite corners of the annular plate 97, and the third and fourth pads 933, 934 are fixed to the remaining corners of the annular plate 97, for example by welding, adhesives, or other suitable methods of attachment.

An implementation of the first drive arrangement 11 is connected to the second annular plate 98 (first part 24), and although not shown in FIGS. 39A to 41, the SMA wires 14₁, 14₂, 14₃, 14₄ are connected between the second annular plate 98 (first part 24) and a structure (not shown) which is fixed to the annular plate 97 (second part 25) or a base 5 to which the annular plate 97 is mounted. The second annular plate 98 (first part 24) may serve as a lens carriage 9 for mounting of one or more lenses 10.

When assembled, the sixth bearing 88 provides a first set of helical flexures 91₁, 91₂ configured to be compliant in directions, corresponding to movements Tz, Tx of the first part 24 relative to the second part 25 along the primary axis z and/or the first axis x. This first set of helical flexures 91₁, 91₂ is mechanically connected in series with a first set of flexures, i.e. the first and second beam portions 95₁, 95₂, configured to be compliant in a direction corresponding to movement Ty of the first part 24 relative to the second part 25 along the second axis y. Similarly, the seventh bearing 89 provides a second set of helical flexures 91₃, 91₄ configured to be compliant in directions corresponding to movements Tz, Ty of the first part 24 relative to the second part 25 along the primary axis z and/or the second axis y. This second set of helical flexures 91₃, 91₄ is mechanically connected in series with a second set of flexures, i.e. the third and fourth beam portions 95₃, 95₄, configured to be compliant in a direction corresponding to movement Tx of the first part 24 relative to the second part 25 along the first axis x.

The pre-formed first and second beam portions 95₁, 95₂ urge the first rigid frame 90₁ upwards against the second part 25 (annular plate 97), and the pre-formed third and fourth beam portions 95₃, 95₄ urge the second rigid frame 90₂ upwards against the first rigid frame 90₁. Hence, when the beam portions 95₁, 95₃, 95₄ deform, the upper surface of the first rigid frame 90₁ slides over the lower surface of the second part 25 (annular plate 97) and/or the upper surface of the second rigid frame 90₂ slides over the lower surface of the second part 25 (annular plate 97) and/or the first rigid frame 90₁. Bearings (not shown) are preferably included to facilitate this sliding. These bearings may be formed by coating at least part of the surfaces with a suitable material, e.g. a polymer as described herein. Alternatively, these bearings may correspond, for example, to implementations of the first or second planar bearings 1064, 1068 between the surfaces.

In use, if the first drive assembly 11 applies a net force oriented in a direction along the first axis x, then the first part 24 will move Tx relative to the second part 25 by deflection of the third and fourth flexures 95₃, 95₄ in the direction of the force and also by deflection of the first and second helical flexures 91₁, 91₂ in the direction of the force.

Due to the deflection of the first and second flexures 95₁, 95₂, any deflection of the third and fourth helical flexures 91₃, 91₄ in the direction of the force is minimised compared to deflection of the first and second helical flexures 91₁, 91₂. Deflection of the third and fourth helical flexures 91₃, 91₄ in the direction along the first axis x is undesirable because it will cause rotation Rx (tilting) of the first part 24 relative to the second part 25 about the first axis x. In contrast, deflection of the first and second helical flexures 91₁, 91₂ in the direction along the first axis x causes minimal rotation Rx due to their geometry.

Similarly, if the first drive assembly 11 applies a force oriented along the second axis y, then the first part 24 will move Ty relative to the second part 25 by deflection of the third and fourth helical flexures 91₃, 91₄ in the direction of the force, and also by deflection of the first and second flexures 95₁, 95₂ in the direction of the force. A force applied along the second axis y may cause some deflection of the first and second helical flexures 91₁, 91₂, which should be minimised because this will cause rotation Ry (tilting) of the first part 24 relative to the second part 25 about the second axis y.

If the first drive assembly 11 applies a force oriented between the first and second axes x, y, then a combination of the hereinbefore described deflections will occur.

If the first drive assembly 11 applies a torque about the primary axis z, then the fixture of both rigid beams 94₁, 94₂ to the second part 24 prevents deflections of the flexures 95₁, 95₂, 95₃, 95₄, so that the torque is transmitted to the respective rigid frames 90₁, 90₂. The helical flexures 91₁, 91₂, 91₃, 91₄ respond to the applied torque by guiding a helical motion [Tz, Rz] of the first part 24 relative to the second part 25 about and along the primary axis z.

In this way, AF and OIS functions may be provided using a drive arrangement 11 including only four SMA wires 14₁, 14₂, 14₃, 14₄, in combination with a pair of bearings 88, 89 which are simple to manufacture and assemble. Indeed, as the seventh bearing 89 may be identical to the sixth bearing 88 except for a 90 degree rotation, only a single part needs to be manufactured for the bearing arrangement 26. Flexures are simpler to assemble than rolling bearings, and have the additional advantage of providing their own restoring forces, enabling omission of additional springs, magnets or other biasing means.

In some examples, the plate 97 need not be annular and the central aperture 1009 may be omitted to allow an image sensor 6 may be mounted directly to the centre of the plate 97 (which will not be annular in this case).

Although the sixth actuator assembly 87 has been explained with the second part 25 corresponding to a support structure 4 of a camera and the first part 24 corresponding to a lens carriage 9 of a lens assembly 3, the roles may be reversed so that the second part 25 corresponds to a lens carriage 9 and the first part 24 provides a support structure 4. Equally, the sixth actuator assembly 87 need not be restricted to use in a camera 1, and the first and second parts 24, 25 may be any parts requiring the relative motions Tx, Ty and/or [Tz, Rz].

Although the sixth actuator assembly 87 has been explained using the first drive assembly 11, the second drive assembly 20 could be used instead.

In the sixth actuator assembly 87, a force applied along the first axis x may still cause some deflection of the third and fourth helical flexures 91₃, 91₄, which will be accompanied by some unwanted tilting Rx of the first part 24 relative to the second part 25 about the first axis x. Similarly, a force applied along the second axis y may cause some deflection of the first and second helical flexures 91₁, 91₂, which will be accompanied by some unwanted tilting Ry of the first part 24 relative to the second part 25 about the second axis y.

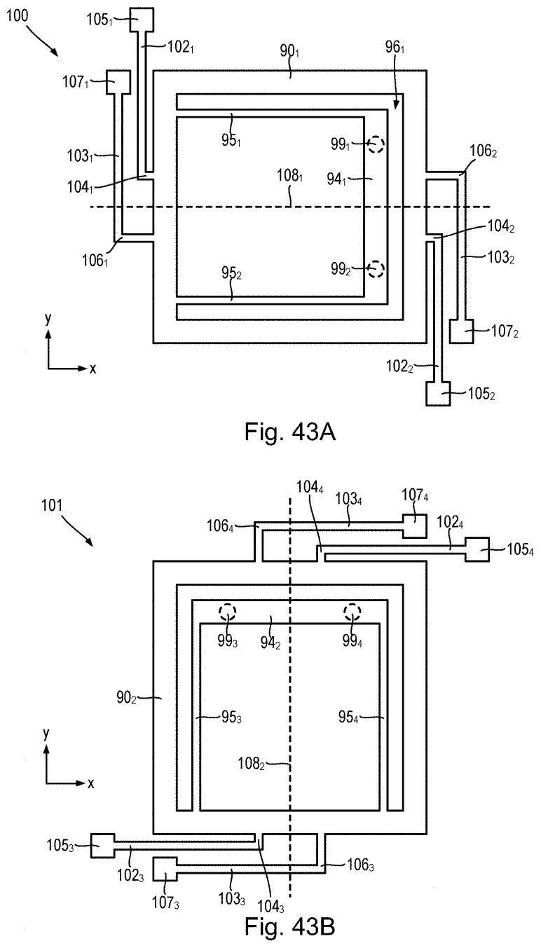

Referring also to FIGS. 43A and 43B, tilt-resistant sixth and seventh bearings 100, 101 are shown.

The tilt-resistant sixth bearing 100 is the same as the sixth bearing 88, except that each helical flexure 91 is replaced with a pair of primary and secondary helical flexures 102, 103. For example, the first helical flexure 91₁ is replaced by a first primary helical flexure 102₁ and first secondary helical flexure 103₁. The first primary helical flexure 102₁ is connected to the first frame 90₁ by a first primary elbow 104₁ at one end, and terminates in a pad 105₁ at the other, free end. Similarly, the first secondary helical flexure 103₁ is connected to the first frame 90₁ by a first secondary elbow 106₁ at one end, and terminates in a pad 107₁ at the other, free end. The first elbows 104₁, 106₁ are equally spaced on opposite sides of a midline 108₁ of the first frame 90₁ running parallel to the first axis x.

Each of the second, third and fourth helical flexures 91₂, 91₃, 91₄ are similarly replaced with a pair of primary 102₂, 102₃, 102₄ and secondary 103₂, 103₃, 103₄ helical flexures.

When the sixth and seventh bearings 88, 89 are replaced with the tilt-resistant sixth and seventh bearings 100, 101, undesired tilting of the first part 24 of the sixth actuator assembly 87 may be minimised.

Referring again to FIG. 41, it may be noted that the second annular plate 98, the rigid beams 94₁, 94₂ and the frames 90₁, 90₂ will all tilt (rotate) together about the first and/or second axes x, y (since they are urged together by the flexures 95₁, 95₂, 95₃, 95₄ as described hereinbefore). Consequently, when using the standard sixth and seventh bearings 88, 89, tilting about the first axis x will apply torsion at the first and second elbows 92₁, 92₂, and tilting about the second axis y will apply torsion at the third and fourth elbows 923, 934.

By contrast, when using the tilt-resistant sixth and seventh bearings 100, 101, tilting about the first axis x, for example clockwise about the first axis x, would require the first primary helical flexure 102₁ to deflect down whilst the first secondary helical flexure 103₁ deflects up. At the same time, the second primary helical flexure 102₂ must deflect up whilst the second secondary helical flexure 103₂ is deflected down. Hence, compared to simple torsion at the first and second elbows 92₁, 92₂, the resistance to tilting (rotation) Rx of the first part 24 about the first axis x is substantially increased. Resistance to tilting (rotation) Ry of the first part 24 about the second axis y is similarly increased.

In this way, the sixth actuator assembly 87 implemented with eight helical flexures 102₁, 102₂, 102₃, 102₄, 103₁, 103₂, 103₃, 103₄ may exhibit improved resistance against unwanted tilting, whilst retaining the advantages of reducing the number of parts and complexity of an actuator assembly for providing combined AF and OIS functions.

Alternative layouts of flexures inside the first and second rigid frame portions 90₁, 90₂ are possible.

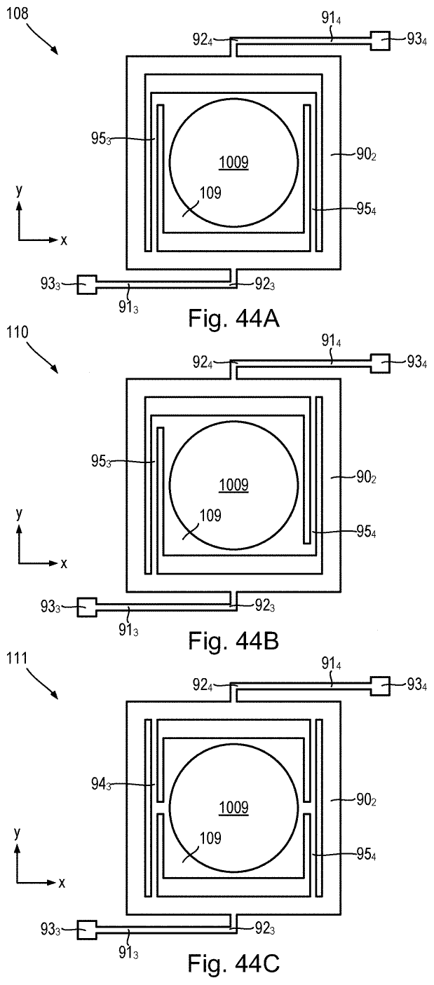

For example, referring also to FIG. 44A, a first alternative split AF bearing 108 is shown.

The first alternative split AF bearing 108 is the same as the seventh bearing 89, except that the rigid beam 94₂ is replaced by a central annular portion 109 having a generally rectangular outer perimeter and a circular inner perimeter defining a central aperture 1009.

The configuration of the first alternative split AF bearing 108 within the second rigid frame 90₂ may equally be used with the tilt resistant sixth and/or seventh bearings 100, 101.

Referring also to FIG. 44B, a second alternative split AF bearing 110 is shown.

The second alternative split AF bearing 110 is the same as the first alternative split AF bearing 108, except that the third beam portion (flexure) 95₃ and the fourth beam portion (flexure) 95₄ no longer extend from the same edge of the second frame 90₂, and instead extend in directions parallel to the second axis y from opposed edges spaced apart in a direction along the second axis y. The beam portions 95₃, 95₄ also connect to opposed edges of the central annular portion 109, spaced apart in a direction along the second axis y.

The configuration of the second alternative split AF bearing 110 within the second rigid frame 90₂ may equally be used with the tilt resistant sixth and/or seventh bearings 100, 101.

Referring also to FIG. 44C, a third alternative split AF bearing 111 is shown.

The third alternative split AF bearing 111 is the same as the first alternative split AF bearing 108, except that the third and fourth beam portions (flexures) 95₃, 95₄ each span across the interior of the second frame 90₂ in a direction parallel to the second axis y. The central annular portion 109 is connected between the mid-points of the third and fourth beam portions (flexures) 95₃, 95₄.

The configuration of the third alternative split AF bearing 111 within the second rigid frame 90₂ may equally be used with the tilt resistant sixth and/or seventh bearings 100, 101.

Seventh Combined AF and OIS Actuator Assembly

The first to sixth actuator assemblies 23, 43, 47, 53, 63, 87 all include a helical bearing or helical flexure to convert applied torque into helical movement [Tz, Rz]. The first to sixth actuator assemblies 23, 43, 47, 53, 63, 87 may use either the flat first drive arrangement 11, or the angled second drive arrangement 20.

The angled drive arrangement 20 is capable of applying net force in a direction along the primary axis z without the need for helical bearings or flexures.

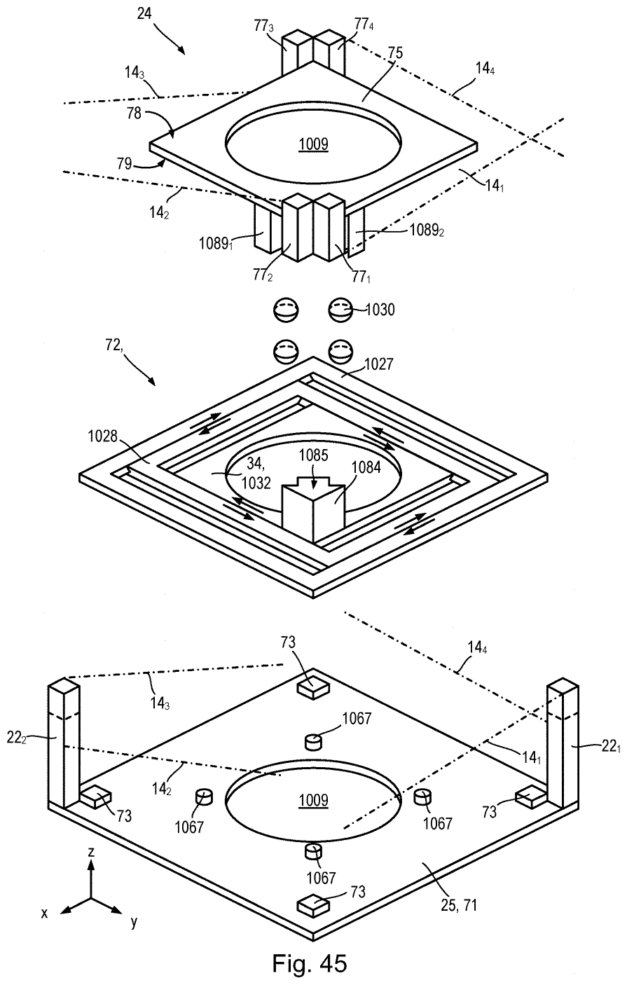

For example, referring also to FIGS. 45 to 47, a seventh combined AF and OIS actuator assembly 70 (hereinafter seventh actuator assembly) is shown.

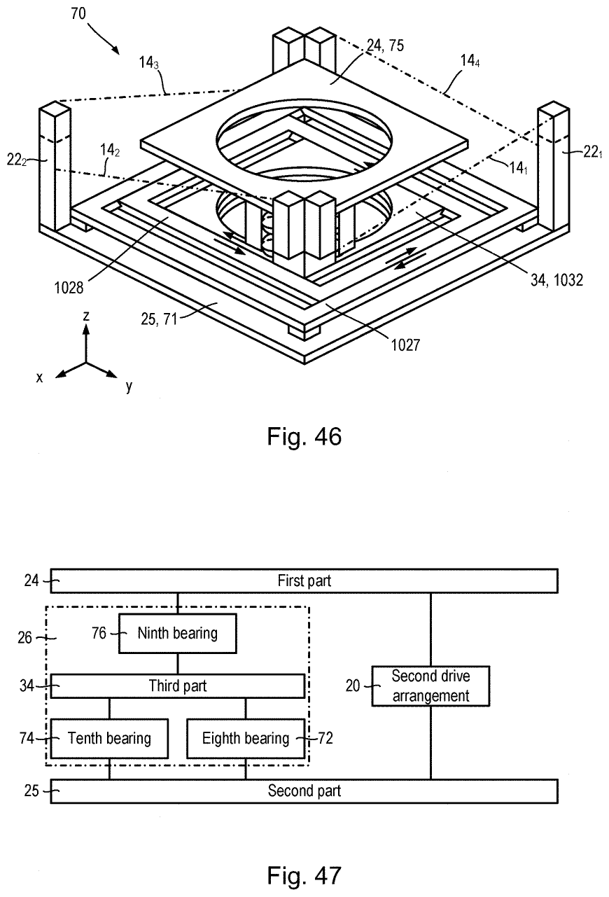

FIG. 45 shows an exploded projection view of the seventh actuator assembly 70, FIG. 46 shows a projection view, and FIG. 47 is a schematic representation.

The seventh actuator assembly 70 takes the form of a four-SMA-wire actuator assembly. The seventh actuator assembly 70 includes a second part 25 in the form of an annular plate 71 having a rectangular outer perimeter and a circular inner perimeter defining a central aperture 1009. In other examples, the central aperture 1009 may be omitted and an image sensor 6 directly mounted to the plate 71 (which would not be annular in such an example). First and second pillars 22₁, 22₁ extend upwards (relative to the primary axis z) from diagonally opposed corners of the annular plate 71 (second part 25).

The bearing arrangement 26 of the seventh actuator assembly 70 is configured to constrain rotation of the first part 24 relative to the second part 25 about the primary axis z. The bearing arrangement 26 includes an eighth bearing 72 mechanically coupling the second part 25 to a third part 34 and configured to guide movement Tx, Ty of the third part 34 relative to the second part 25 along the first axis x and/or the second axis y. The eighth bearing 72 is also configured to constrain rotation of the third part 34 relative to the second part 25 about the primary axis z.

In the example shown in FIGS. 45 and 46, the eighth bearing 72 takes the form of the first x-y bearing 1026 including nested bearing races oriented in directions along (or parallel to) the first and second axes x, y. The first frame 1027 is fixed to the annular plate 71 via four support protrusions 73 arranged in a rectangular configuration. The first frame 1027 is fixed to the support protrusions 73 by welding, adhesives, or another suitable method of attachment. Although shown as corresponding to the corners of the first frame 1027, the support protrusions 73 may be located differently around the first frame 1027, for example at the centres of edges. The central portion 1032 of the first x-y bearing 1026 provides the third part 34 in this example.

Although shown using the first x-y bearing 1026, the eighth bearing 72 may in general may take the same form as the second bearing 35 and/or may include any features and/or functions described in relation to the second bearing 35. For example, the eighth bearing 72 could be, without limitation, any one of the first to third non-rotating general bearings 1013, 1021, 1023, the first or second x-y bearings 1026, 1033 using nested or stacked ball bearing races to guide the movements Tx, Ty, the third x-y bearing 1037 using protrusions 1040 and elongated through holes 1042 to guide movements Tx, Ty, and the fourth x-y bearing 1043 using tabs 1046 to guide movements Tx, Ty of sliding portions 1045.

The bearing arrangement also includes a tenth bearing 74 mechanically coupling the second part 25 to the third part 34 in parallel with the eighth bearing 72. In the example shown in FIGS. 45 and 46, the tenth bearing 74 takes the form of four cylindrical protrusions 1067 extending upwards (relative to the primary axis z) from the annular plate 71. The cylindrical protrusions 1067 are arranged in a rectangular configuration, and provide a first planar bearing 1064 between the annular plate 71 and the second frame 1028 and/or central portion 1032 of the eighth bearing 72 in the form of the first x-y bearing 1026. More or fewer cylindrical protrusions 1067 may be used, though not less than three.

Although with some choices for the eighth bearing 72, for example the first to fourth x-y bearings 1026, 1033, 1037, 1043 the tenth bearing 74 could potentially be omitted, for other options such as the first to third non-rotating general bearings 1013, 1021, 1023, the tenth bearing 74 may be necessary to constrain rotation of the third part 34 relative to the second part 25 about the first and/or second axes x, y. In general, the tenth bearing 74 may take the same form as the third bearing 42 and/or may include any features and/or functions described in relation to the third bearing 42.

The third part 34 in the form of the central portion 1032 is mechanically coupled to a first part 24 in the form of a lens carriage 75 (performing functions of the lens carriage 9) by a ninth bearing 76. The ninth bearing 76 is configured to guide movement Tz of the first part 24 relative to the third part 34 along the primary axis z. The ninth bearing may also constrain movement Tx, Ty of the first part 24 relative to the third part 34 along the first axis x and/or the second axis y, and/or constrain any rotation Rx, Ry, Rz of the first part 24 relative to the third part 34. Some of these constraints may be redundant in combination with some options for the eighth bearing 72.

In the example shown in FIGS. 45 and 46, the ninth bearing 76 takes the form of a z-translation bearing 1081 coupling the central portion 1032 (third part 34) to the lens carriage 75. The lens carriage 75 is annular, with a circular inner perimeter defining a central aperture 1009, and a generally rectangular outer perimeter from which four wire coupling protrusions 77₁, 77₂, 77₃, 77₄ extend. The lens carriage 75 has an upper surface 78 and a lower surface 79 (relative to the primary axis z). The wire coupling protrusions 77₁, 77₂, 77₃, 77₄ extend above the upper surface 78 and below the lower surface 79 of the lens carriage 75. The first and second wire coupling protrusions 77₁, 77₂ extend from a first corner of the lens carriage 75 and the third and fourth wire coupling protrusions 77₃, 77₄ extend from a second corner diagonally opposed to the first. When assembled and viewed from above, four corners of the seventh actuator assembly 70 correspond to a clockwise loop of the first pillar 22₁, the first and second wire coupling protrusions 77₁, 77₂, the second pillar 22₂, and the third and fourth wire coupling protrusions 77₃, 77₄.

The block 1084 of the z-translation bearing 108₁ extends upwards (relative to the primary axis z) from the central portion 103₂ (third part 34). The corresponding cuboidal protrusions 1089₁, 1089₂ of the z-translation bearing 1081 extend downwards (relative to the primary axis z) from the lower surface 79 of the lens carriage 75. The ninth bearing 76 in the form of the z-translation bearing 1081 is assembled by receiving the ball bearings 1030 into the races formed between the block 1084 and the cuboidal protrusions 1089₁, 1089₂.

The ninth bearing 76 is not limited to the z-translation bearing 1081, and any other type of bearing suitable for guiding movement Tz of the first part 24 relative to the third part 34 may be used instead. For example, the z-flexure 1011 may be used instead of the z-translation bearing, or any other bearing providing the motions and constraints described hereinbefore.

The second drive arrangement 20 is completed by connecting the first SMA wire 14₁ angling upwards (relative to the primary axis z) from a lower part of the first wire coupling protrusion 77₁ to the first pillar 22₁, connecting the second SMA wire 14₂ angling downwards (relative to the primary axis z) from an upper part of the second wire coupling protrusion 77₂ to the second pillar 22₂, connecting the third SMA wire 14₃ angling upwards (relative to the primary axis z) from a lower part of the third wire coupling protrusion 77₃ to the second pillar 22₂, and connecting the fourth SMA wire 14₄ angling downwards (relative to the primary axis z) from an upper part of the fourth wire coupling protrusion 77₄ to the first pillar 22₁.

The combination of eighth, ninth and tenth bearings 72, 74, 76 constrains all rotations Rx, Ry, Rz of the first part 24 relative to the second part 25, whilst guiding translations Tx, Ty, Tz along the first, second and/or primary axes x, y, z. This permits combinations of the four SMA wires 14₁, 14₂, 14₃, 14₄ to be used to independently move the first part 24 relative to the second part 25 along the primary axis z to provide an AF function, and/or laterally along first and/or second axes x, y to provide an OIS function. For example, contraction of a pair of opposite SMA wires (e.g. SMA wires 14₁, 14₃) will move the first part along the primary axis z (e.g. up). Contraction of any pair of adjacent SMA wires (e.g. SMA wires 14₃, 14₄) will move the first part in a “diagonal” direction bisecting the pair of SMA actuator wires.

Although the seventh actuator assembly 70 has been explained with the second part 25 corresponding to a support structure 4 of a camera and the first part 24 corresponding to a lens carriage 9, 75 of a lens assembly 3, the roles may be reversed so that the second part 25 corresponds to a lens carriage 9, 75 and the first part 24 provides a support structure 4. Equally, the seventh actuator assembly 70 need not be restricted to use in a camera 1, and the first and second parts 24, 25 may be any parts requiring the relative motions Tx, Ty and/or Tz.

The seventh actuator assembly 70 may provide any or all of the potential advantages of a combined AF and OIS system described hereinbefore, without the requirement for a helical flexure or helical bearing.

Eighth Combined AF and OIS Actuator Assembly

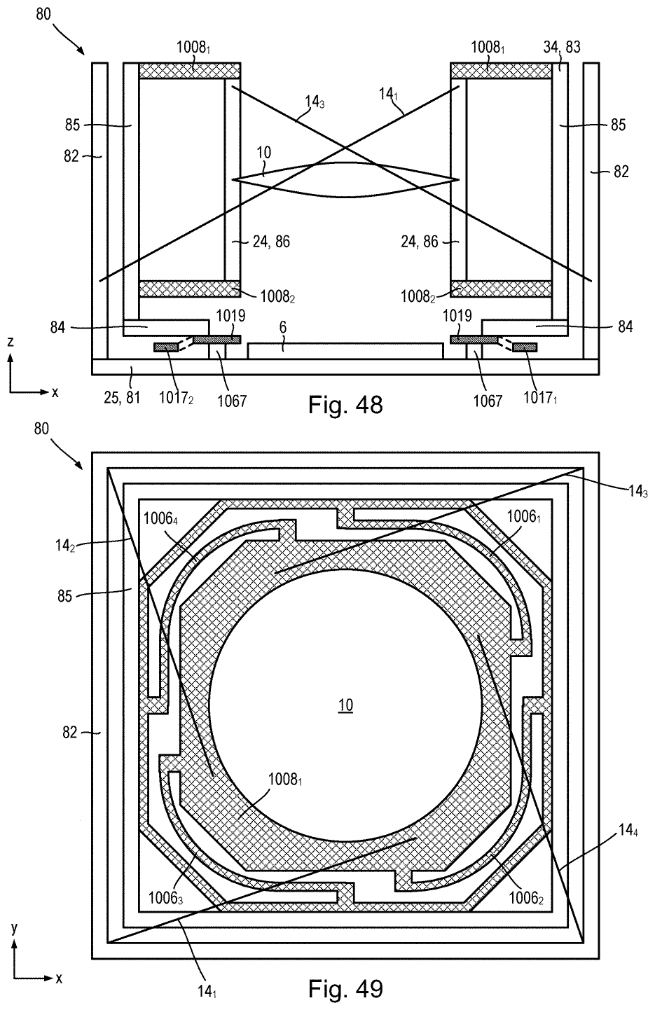

Referring also to FIGS. 48 and 49, an eighth AF and OIS actuator assembly 80 (hereinafter eighth actuator assembly) is shown.

FIG. 48 shows a cross-section through a mid-point of the eighth actuator assembly 80, and FIG. 49 is a top view. In FIGS. 48 and 49, SMA wires 14₁, 14₂, 14₃, 14₄ are superimposed for reference even though these parts would not normally visible in either figure.

The eighth actuator assembly 80 takes the form of a four-SMA-wire actuator assembly. The eighth actuator assembly 80 is the same as the seventh actuator assembly 70, except that the second part 25 is configured differently to the annular plate 71 supporting pillars 22₁, 22₂, the eighth bearing 72 is changed to an implementation of the third non-rotating general bearing 1023, and the ninth bearing 76 is changed to an implementation of the z-flexure 1011.

The second part 25 takes the form of a rectangular plate 81. A wall 82 extends upwards (relative to the primary axis z) around the periphery of the plate 81. As shown, the wall 82 extends continuously around the periphery, but in general the wall 82 need only be provided where connections or SMA wires 14₁, 14₂, 14₃, 14₄ are needed. Alternatively, pillars 22₁, 22₂ may be used instead.

The eighth bearing 72 in the form of the third non-rotating general bearing 1023 is fixed to the plate 81 by the free ends 1024 for the first and second beam portions 1017₁, 1017₂. The central annular portion 1019 of the third non-rotating general bearing 102₃ bears onto at least three, and potentially more cylindrical protrusions 1067 providing a tenth bearing 74 in the form of a first planar bearing 1064. This arrangement causes flexure of the beam portions 1017₁, 1017₂, 1017₃, 1017₄ along the z direction, given rise to restoring forces which urge the central annular portion 1019 into contact with the cylindrical protrusions 1067. An image sensor 6 is mounted on the plate 81, below (relative to the primary axis z) a central aperture 1009 of the central annular portion 1019.

A third part 34 in the form of a support frame 83 is mounted onto the central annular portion 1019 of the eighth bearing 72. The support frame 83 includes a generally rectangular base 84 which includes a central aperture 1009 above (relative to the primary axis z) the image sensor 6. A wall 85 extends upwards (relative to the primary axis z) around the periphery of the rectangular base 84. It should be noted that the wall 85 will include at least four apertures (not shown) to permit connection of the SMA wires 14₁, 14₂, 14₃, 14₄ between the first and second parts 24, 25.

The first part 24 takes the form of a hollow cylinder 86 which is axially aligned with the primary axis z and which provides the rigid structure 1012 of the z-flexure 1011. The top (relative to the primary axis z) of the hollow cylinder 86 (first part 24) is coupled to the wall 85 of the support frame 83 by an upper simple flexure 1008₁ in the form of a second simple flexure 1008, and the bottom (relative to the primary axis z) of the hollow cylinder 86 (first part 24) is coupled to the wall 85 of the support frame 83 by a lower simple flexure 1008₂ in the form of a second simple flexure 1008. The hollow cylinder 86 may be replaced with any other suitable structure, for example having a rectangular annular cross-section in a plane perpendicular to the primary axis z.

An advantage of using flexures such as the third non-rotating general bearing 1023 and a z-flexure 1011 to provide the respective eighth and ninth bearings 72, 76 is that additional biasing means such as springs and/or magnets are not required. The flexures 1023, 1011 themselves provide biasing forces to urge the relative positions of the first and second parts 24, 25 back to an equilibrium position when the SMA wires 14₁, 14₂, 14₃, 14₄ are unpowered.

Helical Flexure Bearing Formed from Sheet Metal

There is disclosed an actuator assembly comprising a support structure; a movable part movable relative to the support structure; and a bearing arrangement configured to guide helical movement of the movable part with respect to the support structure about a helical axis. The bearing arrangement comprises a support plate connected to the support structure; a movable plate connected to the movable part; and at least two flexures connected between the support plate and the movable plate so as to guide helical movement of the movable plate with respect to a support plate about the helical axis. The bearing arrangement is integrally formed from sheet material, for example sheet metal.

At least one actuator component is connected between the support structure and the movable part and arranged to drive rotation of the movable part around the helical axis, said rotation being converted into helical movement around the helical axis by the bearing arrangement.

Integrally forming the bearing arrangement from sheet material may make fabrication of the bearing arrangement simpler.

A single movable plate and/or a single support plate may be connected to each of the at least two flexures. The single movable plate and/or single support plate may thus fix the relative position of the flexures, which may be useful when assembling the actuator assembly.

There is also disclosed a method of manufacturing the actuator assembly. The method comprises providing a bearing arrangement comprising a support plate, a movable plate, and at least two flexures connected between the support plate and the movable plate so as to guide helical movement of the movable plate with respect to a support plate about the helical axis, by providing a piece of sheet material, and selectively removing portions of the piece of sheet material so as to provide the bearing arrangement. The method further comprises mounting a movable part on the movable plate of the bearing arrangement and mounting a support structure on the support plate, such that the bearing arrangement is configured to guide helical movement of the movable part with respect to the support structure about the helical axis; and connecting at least one actuator component between the support structure and the movable part in an arrangement such that the at least one actuator component drives rotation of the movable part around the helical axis, said rotation being converted into helical movement around the helical axis by the bearing arrangement. The bearing arrangement may be provided with a single movable plate and/or a single support plate that connects the flexures. After mounting the movable part on the movable plate and/or after mounting the support structure on the support plate, portions of the single movable plate and/or of the single support plate may be removed to form a plurality of movable plates and/or support plates.

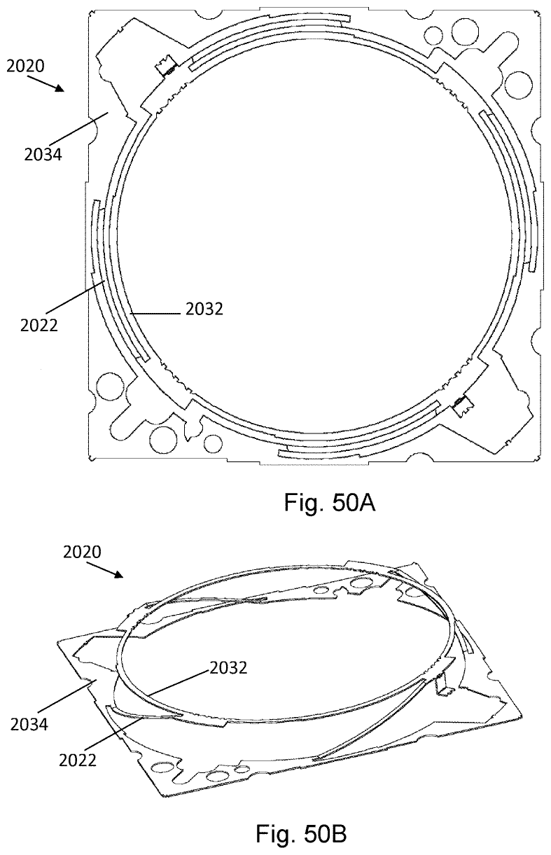

FIGS. 50a and 50b schematically depict a bearing arrangement 2020. The bearing arrangement 2020 is for guiding helical movement of a movable part with respect to a support structure about a helical axis and comprises flexures 2022. The bearing arrangement 2020 may be integrally formed from sheet material. So, all parts of the bearing arrangement 20 may be formed from the sheet material. This may reduce the complexity of fabricating the bearing arrangement 2020, especially when the bearing arrangement 2020 is a miniature bearing arrangement 2020 for use in miniature apparatuses, such as miniature cameras.

The bearing arrangement of FIGS. 50A and 50B may be provided as the bearing arrangement in the actuator assembly described above, or in other actuator assemblies. The bearing arrangement may correspond to, or provided in place of, the “helical flexure bearing” described above, for example in relation to FIG. 24. The flexures may correspond to the “helical beam portions” described above. The movable part may correspond to the “first part” described above, and the support structure may correspond to the “second part” described above.

There is thus provided a bearing arrangement 2020 comprising at least one flexure 2022. Preferably, the bearing arrangement 2020 comprises at least two flexures 2022, for example four flexures 2022. The bearing arrangement may comprise any of the features of the bearing arrangements with flexures described above.

The bearing arrangement 2020 is shown in plan view (along the helical axis H) in FIG. 50A and in perspective view in FIG. 50B. The bearing arrangement 2020 comprises a movable plate 2032 that may be connected to the movable part, and a support plate 2034 that may be connected to the support structure. The bearing arrangement 2020 guides helical movement of the movable plate 2032 with respect to the support plate 2034 about the helical axis H (and thus guides helical movement of the movable part with respect to the support structure about the helical axis H).

The bearing arrangement 2020 is integrally formed from sheet material. Thus, the flexures 2022, the movable plate 2032 and the support plate 2034 may be integrally formed from the sheet material. The sheet material may be sheet metal, for example a sheet of stainless steel or other metal. The sheet material may have a thickness in the range from 5 to 500 μm, preferably from 10 to 200 μm, further preferably from 20 to 80 μm, most preferably from 30 to 50 μm. The bearing arrangement 2020 may have a lateral extent (i.e. perpendicular to the helical axis) in the range from 1 to 16 mm, preferably from 2 to 10 mm, further preferably from 3 to 7 mm.

The sheet material may be electrically conductive. This allows current to be directed to from the support structure to the movable part via the bearing arrangement 2020. The sheet material may be coated with an electrically-insulating dielectric material. The dielectric coating or other type of dielectric layer may include one or more windows allowing electrical connections therethrough.

As shown in FIGS. 50A and 50B, the bearing arrangement 2020 may comprise a single movable plate 2032 that is common to the flexures 2022 of the bearing arrangement 2020. So, all flexures 2022 of the bearing arrangement 2020 may be connected by the movable plate. This fixes the relative position of the flexures 2022, which may be useful when assembling the actuator assembly. The movable plate 2032 may be ring-shaped, i.e. shaped as a circular annulus having a central aperture, for example. Additionally, the bearing arrangement 2020 of FIGS. 50A and 50B comprises a single support plate 2034 that is common to the flexures 2022 of the bearing arrangement 2032. The support plate 2034 connects to all flexures 2022 of the bearing arrangement 2032. The support plate 2034 may be ring-shaped, i.e. shaped as a circular annulus having a central aperture, for example

Alternatively, a plurality of movable plates 2032 and/or support plates 2034 may be provided. For example, the bearing arrangement may comprise individual movable plates 2032 and/or support plates 2034 for each flexure 22.

The bearing arrangement 2020 may be incorporated into an actuator assembly 1, such as the actuator assembly 1 described above.

A method of manufacturing the bearing arrangement 2020 comprises providing a piece of sheet material and selectively removing portions of the piece of sheet material so as to provide the bearing arrangement 2020. The piece of sheet material may be a piece of sheet metal.

Selectively removing portions of the piece of sheet material may comprise selectively etching the sheet material, for example through a photomask or other mask. Such etching may be especially suitable for miniature devices and high-throughput manufacturing. Alternatively, portions of the piece of sheet material may be removed by any other suitable techniques, such as laser ablation or other laser processes, or cutting or stamping out the portions of the piece of sheet material.

Manufacturing the bearing arrangement 2020 may further comprise moving the movable plate 2032 relative to the support plate 2034 in a direction perpendicular to the plane of the sheet material. The flexures 2022 may thus be pre-deflected and are angled relative to the plane of the piece of sheet material.

The bearing arrangement 2020 may then be incorporated into an actuator assembly, for example the actuator assembly described above. A method of manufacturing the actuator assembly comprises connecting the movable plate 2032 of the bearing arrangement 2020 to the movable part of the actuator assembly and connecting the support plate 2034 of the bearing arrangement 2020 to the support structure of the actuator assembly. The bearing arrangement 2020 may be connected to the movable part and/or support structure by any suitable techniques, for example by heat-staking or gluing using an adhesive. An actuator component, for example an SMA wire, may be connected between the support structure and the movable part in an arrangement such that, on actuation or contraction, the actuator component drives rotation of the movable part around the helical axis H. The rotation is converted into helical movement around the helical axis H by the bearing arrangement 2020. The actuator component is connected to the support structure and to the movable part by any suitable techniques, for example by crimping.

The bearing arrangement 2020 may initially be provided with a single movable plate 2032 and/or a single support plate 2034 that connects the flexures 2022, as shown in FIGS. 50A and 50B. The single movable plate 2032 and/or the single support plate 2034 fixes the relative position of the flexures 2022. After connection to the movable part and/or support structure, portions of the movable plate 2032 and/or of the support plate 2034 may be selectively removed. Multiple movable plates 2032 and/or multiple support plates 2034 may be formed, for example an individual movable plate 2032 and/or an individual support plate 2034 for each flexure 2022. This may make space for other components of the actuator assembly, or make the actuator assembly lighter and more compact. The flexures 2022 may be held in place due to their connection to the movable part and/or to the support structure.

Whilst the embodiments above have described actuator assemblies which use SMA wires, the skilled person will appreciate that the features of the bearing arrangements and the flexures described can be readily used with other forms of actuator components. For example, each actuator component may be a voice coil motor (VCM) actuator, but other types of actuator are possible, for example a piezoelectric actuator, a radial motor or others.

Clause 1. An actuator assembly comprising: a support structure; a movable part movable relative to the support structure; a bearing arrangement configured to guide helical movement of the movable part with respect to the support structure about a helical axis, the bearing arrangement comprising: a support plate connected to the support structure; a movable plate connected to the movable part; and at least two flexures connected between the support plate and the movable plate so as to guide helical movement of the movable plate with respect to a support plate about the helical axis; wherein the bearing arrangement is integrally formed from sheet material; and at least one actuator component connected between the support structure and the movable part and arranged to drive rotation of the movable part around the helical axis, said rotation being converted into helical movement around the helical axis by the bearing arrangement.

Clause 2. The actuator assembly of clause 1, wherein the bearing arrangement is integrally formed from sheet metal.

Clause 3. The actuator assembly of clause 1 or 2, wherein a single movable plate and/or a single support plate is or are connected to each of the at least two flexures.

Clause 4. The actuator assembly of any preceding clause, wherein each flexure extends in an arc around the helical axis.

Clause 5. The actuator assembly of any preceding clause, wherein each flexure is pre-deflected along the helical axis.

Clause 6. The actuator assembly of any preceding clause, wherein the flexures extend along the helical axis and are inclined with respect to a plane perpendicular to the helical axis with rotational symmetry around the helical axis.

Clause 7. The actuator assembly according to any one of the preceding clauses, wherein the bearing arrangement comprises at least four flexures, preferably five flexures.

Clause 8. The actuator assembly of any one of the preceding clauses, wherein the actuator component is formed from shape memory alloy.

Clause 9. The actuator assembly of any preceding clause, wherein the bearing arrangement has a maximum lateral extent in the range from 1 to 16 mm, preferably from 3 to 7 mm.

Clause 10. The actuator assembly of any preceding clause, wherein the sheet material has a thickness in the range from 5 to 500 μm, preferably from 20 to 80 μm.

Clause 11. A camera apparatus comprising: the actuator assembly of any preceding clause; and an image sensor that is fixed relative to the support structure of the actuator assembly; wherein the movable part of the actuator assembly comprises a lens assembly having one or more lenses that is configured to focus an image onto the image sensor.

Clause 12. A camera apparatus according to clause 11 further including a controller arranged to control the position of the lens assembly relative to the image sensor by controlling the actuator component.

Clause 13. A method of manufacturing the actuator assembly of any one of clauses 1 to 10, the method comprising: providing a bearing arrangement comprising a support plate, a movable plate, and at least two flexures connected between the support plate and the movable plate so as to guide helical movement of the movable plate with respect to a support plate about the helical axis, by: providing a piece of sheet material, and selectively removing portions of the piece of sheet material so as to provide the bearing arrangement; mounting a movable part on the movable plate of the bearing arrangement and mounting a support structure on the support plate, such that the bearing arrangement is configured to guide helical movement of the movable part with respect to the support structure about the helical axis; and connecting at least one actuator component between the support structure and the movable part in an arrangement such that the at least one actuator component drives rotation of the movable part around the helical axis, said rotation being converted into helical movement around the helical axis by the bearing arrangement.

Clause 14. The method of clause 13, wherein providing the bearing arrangement comprises providing a bearing arrangement with a single movable plate and/or a single support plate that connects the flexures; and after mounting the movable part on the movable plate and/or after mounting the support structure on the support plate, removing portions of the single movable plate and/or of the single support plate to form a plurality of movable plates and/or support plates.

It will be appreciated that there may be many other variations of the above-described embodiments.

In the description hereinbefore, parts have been described as rectangular, and this should be interpreted as encompassing square shapes. In the description hereinbefore, parts have been described as circular, and this should be interpreted as encompassing elliptical shapes.

The first to fourth SMA wires 14₁, 14₂, 14₃, 14₄ have been described and shown as directly connecting the first and second parts 24, 25, the first and third parts 24, 28 or the second and third parts 25, 28. However, in some examples the first to fourth SMA wires 14₁, 14₂, 14₃, 14₄ may indirectly connect the first and second parts 24, 25, the first and third parts 24, 28 or the second and third parts 25, 28, for example via one or more intermediate structures (not shown). Intermediate structures (not shown) may be configured to help extend the stroke of one or more SMA wires 14₁, 14₂, 14₃, 14₄.

The actuator assembly may be any type of assembly that comprises a first part which is movable with respect to a second part. The actuator assembly may be, or may be provided in, any one of the following devices: a smartphone, a protective cover or case for a smartphone, a functional cover or case for a smartphone or electronic device, a camera, a foldable smartphone, a foldable smartphone camera, a foldable consumer electronics device, a camera with folded optics, an image capture device, an array camera, a 3D sensing device or system, a servomotor, a consumer electronic device, a mobile or portable computing device, a mobile or portable electronic device, a laptop, a tablet computing device, an e-reader, a computing accessory or computing peripheral device, an audio device, a security system, a gaming system, a gaming accessory, a robot or robotics device, a medical device, an augmented reality system, an augmented reality device, a virtual reality system, a virtual reality device, a wearable device, a drone, an aircraft, a spacecraft, a submersible vessel, a vehicle, and an autonomous vehicle, a tool, a surgical tool, a remote controller, clothing, a switch, dial or button, a display screen, a touchscreen, a flexible surface, and a wireless communication device. It will be understood that this is a non-exhaustive list of example devices.

1. An actuator assembly comprising:
a first part;
a second part;
a bearing arrangement mechanically coupling the first part to the second part;
a drive arrangement comprising a total of four lengths of shape memory alloy wire;
wherein the drive arrangement and the bearing arrangement are configured such that the first part is movable towards or away from the second part along a primary axis, and the first part is movable relative to the second part along a first axis and/or a second axis;
wherein the first and second axes are perpendicular to the primary axis and the second axis is different to the first axis.

2. The actuator assembly according to claim 1, wherein the bearing arrangement comprises a first bearing configured to generate, in response to a torque applied about the primary axis by the drive arrangement, movement of the first part towards or away from the second part along the primary axis.

3. The actuator assembly according to claim 2, wherein a rotation of the first bearing about the primary axis corresponds to a rotation of the first part relative to the second part.

4. The actuator assembly according to claim 3, wherein the first bearing mechanically couples the second part to a third part, and wherein each of the four lengths of shape memory alloy wire connects the first part to the second part;
wherein the bearing arrangement comprises a second bearing mechanically coupling the first part to the third part and configured to guide movement of the first part relative to the third part along the first axis and/or the second axis.

5. The actuator assembly according to claim 4, wherein the second bearing constrains rotation of the first part relative to the third part about the primary axis.

6. (canceled)

7. The actuator assembly according to claim 4, wherein the second bearing comprises one of:
a first ball-bearing race aligned with the first axis and connected in series with a second ball-bearing race aligned with the second axis; and
a first set of flexures connected in series with a second set of flexures,
wherein the first set of flexures are configured to be compliant in a direction corresponding to movement of the first part relative to the third part along the first axis and the second set of flexures are configured to be compliant in a direction corresponding to movement of the first part relative to the third part along the second axis.

8. (canceled)

9. The actuator assembly according to claim 4, wherein the bearing arrangement further comprises a third bearing mechanically coupling the first part to the third part in parallel with the second bearing, wherein the third bearing is configured to constrain movement of the first part relative to the third part along the primary axis, and to constrain rotation of the first part relative to the third part about the first or second axes.

10. The actuator assembly according to claim 2, wherein the bearing arrangement is further configured to constrain rotation of the first part relative to the second part about the primary axis.

11. The actuator assembly according to claim 10, wherein the first bearing mechanically couples the first part to a third part, and wherein each of the four lengths of shape memory alloy wire connects the second part to the third part;
wherein the bearing arrangement further comprises a fourth bearing mechanically coupling the first part to the second part and configured to guide movement of the first part relative to the second part along the first axis and/or the second axis.

12. The actuator assembly according to claim 11, wherein the fourth bearing is configured to constrain rotation of the first part relative to the second part about the primary axis.

13. The actuator assembly according to claim 11, wherein the fourth bearing comprises a first set of flexures connected in series with a second set of flexures;
wherein the first set of flexures are configured to be compliant in a direction corresponding to movement of the first part relative to the second part along the first axis and the second set of flexures are configured to be compliant in a direction corresponding to movement of the first part relative to the second part along the second axis.

14. (canceled)

15. The actuator assembly according to claim 11, wherein the bearing arrangement further comprises a fifth bearing mechanically coupling the second part to the third part connected in parallel with the four lengths of shape memory alloy wire, wherein the fifth bearing is configured to constrain movement of the third part relative to the second part along the primary axis, and to constrain rotation of the third part relative to the second part about the first or second axes.

16. The actuator assembly according to claim 2, wherein the bearing arrangement comprises sixth and seventh bearings, each mechanically coupling the first part to the second part, the sixth and seventh bearings connected in parallel, and wherein each of the four lengths of shape memory alloy wire connects the first part to the second part;
wherein the sixth bearing comprises a first set of helical flexures configured to be compliant in directions corresponding to movement of the first part relative to the second part along the primary axis and/or the first axis, the first set of helical flexures connected in series with a third set of flexures configured to be compliant in a direction corresponding to movement of the first part relative to the second part along the second axis;
wherein the seventh bearing comprises a second set of helical flexures configured to be compliant in directions corresponding to movement of the first part relative to the second part along the primary axis and/or the second axis, the second set of helical flexures connected in series with a fourth set of flexures configured to be compliant in a direction corresponding to movement of the first part relative to the second part along the first axis.

17.-18. (canceled)

19. The actuator assembly according to claim 10, wherein each of the four lengths of shape memory alloy wire connects the first part to the second part, and wherein the bearing arrangement comprises:
an eighth bearing mechanically coupling the second part to a third part and configured to guide movement of the third part relative to the second part along the first axis and/or the second axis;
a ninth bearing mechanically coupling the first part to the third part and configured to guide movement of the first part relative to the third part along the primary axis, wherein the eighth bearing is configured to constrain rotation of the third part relative to the second part about the primary axis.

20. (canceled)

21. The actuator assembly according to claim 19, wherein the bearing arrangement further includes a tenth bearing mechanically coupling the second part to the third part in parallel with the eighth bearing, wherein the tenth bearing is configured to constrain movement of the third part relative to the second part along the primary axis, and to constrain rotation of the third part relative to the second part about the first or second axes.

22. The actuator assembly according to claim 19, wherein the ninth bearing is configured to constrain movement of the first part relative to the third part along the first axis and/or the second axis, and to constrain any rotation of the first part relative to the third part.

23. (canceled)

24. The actuator assembly according to claim 19, wherein the ninth bearing comprises one of:
a ball-bearing race aligned with the primary axis; and
fifth and sixth sets of flexures, each configured to be compliant in a direction corresponding to movement of the first part relative to the third part along the primary axis, wherein the fifth and sixth sets of flexures are connected in parallel and spaced apart along the primary axis.

25. The actuator assembly according to claim 1, wherein the four lengths of shape memory alloy wire are substantially co-planar within a plane parallel to the first and second axes.

26. (canceled)

27. A camera comprising:
an actuator assembly according to claim 1;
an image sensor supported by one of the first part and the second part;
a lens supported by the other of the first part and the second part.

28. (canceled)

29. A method comprising use of the actuator assembly according to claim 1 to implement an optical image stabilisation function and/or an automatic focussing function of a camera.
